(19) United States
(12) Patent Application Publication
(10) Pub. No.: US 2006/0057023 A1
(43) Pub. Date: Mar. 16, 2006

(54) Chemical arrays assemblies and devices and methods for fabricating the same

(76) Inventors: Allen C. Thompson, Sunnyvale, CA (US); Jacqueline M. Tso, Los Gatos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/941,968

(22) Filed: Sep. 14, 2004

(51) Int. Cl. B01J 19/00

(52) U.S. Cl. 422/58; 422/130

(57) ABSTRACT

The subject invention provides array assemblies that include at least one array of an addressable set of probes and devices, as well as methods for fabricating and using the same. Embodiments include array assemblies that include a base supporting a plurality of prongs wherein at least one prong includes an array of an addressable set of probes. Embodiments of the subject methods include generating at least one chemical array on a surface of at least one prong of a device that includes a base supporting a plurality of prongs. The subject invention also includes methods for performing array assays. Systems and kits for practicing the subject methods are also provided.

### BACKGROUND OF THE INVENTION

Chemical arrays such as biopolymer arrays (for example polynucleotide array such as DNA or RNA arrays), are known and are used, for example, as diagnostic or screening tools. Such arrays include regions of usually different sequence polynucleotides arranged in a predetermined configuration on a substrate. These regions (sometimes referenced as “features”) are positioned at respective locations (“addresses”) on the substrate. The arrays, when exposed to a sample, will exhibit an observed binding pattern. This binding pattern can be detected upon interrogating the array. For example all polynucleotide targets (for example, DNA) in the sample can be labeled with a suitable label (such as a fluorescent compound), and the fluorescence pattern on the array accurately observed following exposure to the sample. Assuming that the different sequence polynucleotides were correctly deposited in accordance with the predetermined configuration, then the observed binding pattern will be indicative of the presence and/or concentration of one or more polynucleotide components of the sample.

Arrays can be fabricated by depositing previously obtained biopolymers onto a substrate, or by in situ synthesis methods. The in situ fabrication methods include those described in U.S. Pat. No. 5,449,754 for synthesizing peptide arrays, and in U.S. Pat. No. 6,180,351 and WO 98/41531 and the references cited therein for synthesizing polynucleotide arrays. Further details of fabricating biopolymer arrays are described in U.S. Pat. No. 6,242,266, U.S. Pat. No. 6,232,072, U.S. Pat. No. 6,180,351, and U.S. Pat. No. 6,171,797. Other techniques for fabricating biopolymer arrays include known light directed synthesis techniques. Methods for sample preparation, labeling, and hybridizing are disclosed for example in U.S. Pat. No. 6,201,112, U.S. Pat. No. 6,132,997, U.S. Pat. No. 6,235,483, and U.S. patent publication 20020192650.

After an array has been exposed to a sample, the array is read with a reading apparatus (such as an array “scanner”) which detects the signals (such as a fluorescence pattern) from the array features. The signal image resulting from reading the array may then be digitally processed to evaluate which regions (pixels) of read data belong to a given feature as well as the total signal strength from each of the features. The foregoing steps, separately or collectively, are referred to as “feature extraction”.

In certain chemical array embodiments, a plurality of chemical arrays is associated with the same substrate, i.e., spaced-apart on a substrate surface. Cross-contamination of sample contacted with the arrays is of concern in such embodiments. If the arrays are too close together, cross-contamination between samples may occur. However, increasing spacing between the arrays reduces the number of arrays that may be provided. Accordingly, a balance between providing a high density of arrays on a substrate surface and preventing cross-contamination must be maintained when such arrays are designed and fabricated.

Accordingly, there continues to be an interest in the design and fabrication of chemical arrays, e.g., chemical arrays in a format that prevents cross-contamination of samples contacted with different arrays of the same substrate. Of interest are methods and devices for fabricating chemical arrays in a high-throughput format.

### SUMMARY OF THE INVENTION

The subject invention provides array assemblies that include at least one array of an addressable set of probes and devices, as well as methods, for fabricating and using the same. Embodiments include array assemblies that include a base supporting a plurality of prongs wherein at least one prong includes an array of an addressable set of probes. Embodiments of the subject methods include generating at least one chemical array on a surface of at least one prong of a device that includes a base supporting a plurality of prongs. The subject invention also includes methods for performing array assays. Systems and kits for practicing the subject methods are also provided.

### BRIEF DESCRIPTION OF THE DRAWINGS

FIG. 1 shows an exemplary embodiment of an array assembly according to the subject invention having a base supporting a plurality of prongs wherein at least one addressable chemical array is generated on a surface of at least one the prongs.

FIG. 2 shows an enlarged view of a portion of surface of a prong of FIG. 1 showing spots or features.

FIG. 3 is an enlarged view of a portion of the surface of FIG. 2.

FIG. 4 shows a cross-sectional view through an exemplary base/prong device of the subject invention.

FIG. 5 shows an enlarged view of a portion of the device of FIG. 4 showing optional layers overlaying a base.

FIGS. 6A and 6B show exemplary embodiments of the subject invention wherein FIG. 6A shows an exemplary prong of the subject invention having optional layers on a top surface of the prong and FIG. 6B shows an exemplary prong of the subject invention having optional layers on a top surface of the prong as well as the sides of the prong.

FIG. 7 shows an exemplary embodiment of a fluid contacting plate according to the subject invention.

FIG. 8 shows a portion of the fluid contacting plate of FIG. 7.

FIG. 9 shows a cross sectional view through an exemplary embodiment according to the subject invention that includes an exemplary base/prong device positioned in a carrier and an exemplary fluid contacting plate operatively positioned relative to the device and a flow cell positionable about the structure.

FIG. 10 shows an exemplary embodiment of an apparatus which may be employed in the practice of the subject invention.

FIG. 11 shows an exemplary embodiment of an array reader which may be employed to read arrays of the subject invention.

FIGS. 12A-12D show an exemplary embodiment of manufacturing a base/multi-prong device with substantially flat surfaces on top of the prongs using a one-piece structure of a plurality of prongs having top surfaces that are interconnected by a web of material, wherein the interconnected material has a surface that is coplanar with the top surfaces of the prongs and onto which one or more chemical arrays having an addressable set of probes are generated on a surface of at least one prong and a portion of the structure is then cut-away to remove material that interconnects the top surfaces of the prongs to reveal a plurality of prongs that are not interconnected by a web of material and which have at least one chemical array of an addressable set of probes generated directly on a surface of at least one prong.

To facilitate understanding, identical reference numerals have been used, where practical, to designate the same elements which are common to different figures. Drawings are not necessarily to scale. Throughout this application any different members of a generic class may have the same reference number followed by different letters (for example, arrays 12a, 12b, 12c, and 12d may generically be referenced as “arrays 12”)

### DEFINITIONS

Throughout the present application, unless a contrary intention appears, the following terms refer to the indicated characteristics.

A “biopolymer” is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. Specifically, a “biopolymer” includes DNA (including cDNA), RNA (including CRNA) and oligonucleotides, regardless of the source.

A “biomonomer” references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.

An “oligonucleotide” generally refers to a nucleotide multimer of about 10 to 100 nucleotides in length, while a “polynucleotide” includes a nucleotide multimer having any number of nucleotides.

A chemical “array”, unless a contrary intention appears, includes any one, two or three-dimensional arrangement of addressable regions bearing a particular chemical moiety or moieties (for example, biopolymers such as polynucleotide sequences) associated with that region. For example, each region may extend into a third dimension from a substrate surface. An array is “addressable” in that it has multiple regions (sometimes referenced as “features” or “spots” of the array) of different moieties (for example, different polynucleotide sequences) such that a region at a particular predetermined location (an “address”) on the array will detect a particular target or class of targets (although a feature may incidentally detect non-targets of that feature). An array feature is generally homogenous in composition and concentration and the features may be separated by intervening spaces (although arrays without such separation can be fabricated). In the case of an array, the “target” will be referenced as a moiety in a mobile phase (typically fluid), to be detected by probes (“target probes”) which are bound to the substrate at the various regions. However, either of the “target” or “target probes” may be the one which is to be detected by the other (thus, either one could be an unknown mixture of polynucleotides to be detected by binding with the other). Arrays may be considered different from each other if at least one feature of a first array is different (e.g., has a different chemical moiety) from at least one feature of a second array. “Addressable set of probes” and analogous terms refers to the multiple regions of different moieties supported by or intended to be supported by the array substrate surface, e.g., the surfaces of prongs of a device that includes a base supporting a plurality of prongs A set of probes means a plurality of probes.

A “fluid contacting plate” is meant any structure used with a device having a base supporting a plurality of prongs during a fluid contact process. Fluid contacting plates include bases having a plurality of holes dimensioned according to prongs with which they are designed to be used.

An “array layout” or “array characteristics”, refers to one or more physical, chemical or biological characteristics of the array, such as positioning of some or all the features within the array and on a substrate, one or more feature dimensions, or some indication of an identity or function (for example, chemical or biological) of a moiety at a given location, or how the array should be handled (for example, conditions under which the array is exposed to a sample, or array reading specifications or controls following sample exposure).

“Hybridizing” and “binding”, with respect to polynucleotides, are used interchangeably.

A “substantially flat” surface refers to a surface that has minimal deviation, e.g., does not deviate by more than about 0.001 mm to about 1 mm, e.g., by not more than about 0.002 mm to about 0.5 mm, e.g., by not more than about 0.005 mm to about 0.100 mm in certain embodiments.

A “plastic” is any synthetic organic polymer of high molecular weight (for example at least 1,000 grams/mole, or even at least 10,000 or 100,000 grams/mole.

A “web” references a long continuous piece of substrate material, e.g., having a length greater than a width in certain embodiments. For example, the web length to width ratio may be at least 5/1, 10/1, 50/1, 100/1, 200/1, or 500/1, or even at least 1000/1 in certain embodiments, or even 10,000/1 or greater, depending on the length of the web.

The term “light returning” refers to the change in direction which occurs when an electromagnetic wave strikes a surface and is thrown back. In certain embodiments, a “light returning layer” refers to a material which reflects or returns about 2% to about 100% light from passing through, e.g., from about 5% to about 100% light from passing through.

The term “transparent” refers to permitting light to pass therethrough without substantial attenuation or distortion. In certain embodiments, transparent may refer to permitting from about 2% to about 100% of light to pass through, e.g., from about 5 to about 100% of light to pass through.

By “without substantial attenuation” may include, for example, without a loss of more than about 40% of light, e.g., without a loss of more than about 30%, without a loss of more than about 20%, without a loss of more than about 10%, without a loss of more than about 5% or less.

An “apparatus for generating an array of an addressable set of probes on a surface of at least one of said prongs” means any apparatus that may be employed for such a process including, but not limited to, a syringe, fluid drop deposition device (e.g., a pulse jet fluid drop deposition device) or the like.

“Flexible” with reference to a substrate or substrate web (including a housing or one or more housing component such as a housing base and/or cover), references that the substrate can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a substrate (including a housing or one or more housing component such as a housing base and/or cover) which is not flexible, and is constructed such that a segment about 2.5 by 7.5 cm retains its shape and cannot be bent along any direction more than 60 degrees (and often not more than 40, 20, 10, or 5 degrees) without failure (for example, cracking) or plastic deformation.

When one item is indicated as being “remote” from another, this is referenced that the two items are at least in different buildings, and may be at least one mile, ten miles, or at least one hundred miles apart. When different items are indicated as being “local” to each other they are not remote from one another (for example, they can be in the same building or the same room of a building). “Communicating”, “transmitting” and the like, of information reference conveying data representing information as electrical or optical signals over a suitable communication channel (for example, a private or public network, wired, optical fiber, wireless radio or satellite, or otherwise). Any communication or transmission can be between devices which are local or remote from one another. “Forwarding” an item refers to any means of getting that item from one location to the next, whether by physically transporting that item or using other known methods (where that is possible) and includes, at least in the case of data, physically transporting a medium carrying the data or communicating the data over a communication channel (including electrical, optical, or wireless). “Receiving” something means it is obtained by any possible means, such as delivery of a physical item (for example, an array or array carrying package). When information is received it may be obtained as data as a result of a transmission (such as by electrical or optical signals over any communication channel of a type mentioned herein), or it may be obtained as electrical or optical signals from reading some other medium (such as a magnetic, optical, or solid state storage device) carrying the information. However, when information is received from a communication it is received as a result of a transmission of that information from elsewhere (local or remote).

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. Items of data are “linked” to one another in a memory when a same data input (for example, filename or directory name or search term) retrieves those items (in a same file or not) or an input of one or more of the linked items retrieves one or more of the others. In particular, when an array layout is “linked” with an identifier for that array, then an input of the identifier into a processor which accesses a memory carrying the linked array layout retrieves the array layout for that array.

A “computer”, “processor” or “processing unit” are used interchangeably and each references any hardware or hardware/software combination which can control components as required to execute recited steps. For example a computer, processor, or processor unit includes a general purpose digital microprocessor suitably programmed to perform all of the steps required of it, or any hardware or hardware/software combination which will perform those or equivalent steps. Programming may be accomplished, for example, from a computer readable medium carrying necessary program code (such as a portable storage medium) or by communication from a remote location (such as through a communication channel).

A “memory” or “memory unit” refers to any device which can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

An array “assembly” includes a substrate and at least one chemical array on a surface thereof. Array assemblies may include one or more chemical arrays present on a surface of a device that includes a base supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

“Reading” signal data from an array refers to the detection of the signal data (such as by a detector) from the array. This data may be saved in a memory (whether for relatively short or longer terms).

A “package” is one or more items (such as an array assembly optionally with other items) all held together (such as by a common wrapping or protective cover or binding). Normally the common wrapping will also be a protective cover (such as a common wrapping or box) which will provide additional protection to items contained in the package from exposure to the external environment. In the case of just a single array assembly a package may be that array assembly with some protective covering over the array assembly (which protective cover may or may not be an additional part of the array unit itself).

It will also be appreciated that throughout the present application, that words such as “cover”, “base” “front”, “back”, “top”, “upper”, and “lower” are used in a relative sense only.

“May” refers to optionally.

When two or more items (for example, elements or processes) are referenced by an alternative “or”, this indicates that either could be present separately or any combination of them could be present together except where the presence of one necessarily excludes the other or others.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO4, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

### DETAILED DESCRIPTION OF EMBODIMENTS OF THE INVENTION

The subject invention provides array assemblies that include at least one array of an addressable set of probes and devices, as well as methods for fabricating and using the same. Embodiments include array assemblies that include a base supporting a plurality of prongs wherein at least one prong includes an array of an addressable set of probes. Embodiments of the subject methods include generating at least one chemical array on a surface of at least one prong of a device that includes a base supporting a plurality of prongs. The subject invention also includes methods for performing array assays. Systems and kits for practicing the subject methods are also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All patents and publications mentioned herein are incorporated herein by reference in their entirety. The citation of any patent or publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The figures shown herein are not necessarily drawn to scale, with some components and features being exaggerated for clarity.

Chemical Array Assemblies

As noted above, the subject invention provides chemical array assemblies. The chemical array assemblies of the subject invention find use in a variety of applications, including gene expression analysis, drug screening, nucleic acid sequencing, mutation analysis, and the like. Chemical arrays include a plurality of addressable ligands or molecules or probes (i.e., binding agents or members of a binding pair) generated on a surface of a substrate in the form of an “array” or pattern. Embodiments of the subject invention include array assemblies that include a device having a base structure supporting a plurality of prongs, wherein at least one chemical array is generated on a surface of at least one prong of the device. By prong is meant any structure that extends in a third dimension from the base surface. The base/prong array assemblies provide a number of benefits, such as reducing or all-together preventing cross-contamination between fluids deposited on the top surfaces of different prongs and compatibility with standard multi-well microtiter plates which may be used with the subject array assemblies, e.g., in the performance of array assays (see for example U.S. patent application Ser. No. 10/285,756 (publication no. 20040086869)).

Chemical arrays include at least two distinct polymers that differ from each other in terms of molecular structure attached to different and known locations on a carrier (substrate) surface. For example, where the chemical moieties are polymers, they differ by monomeric sequence. Each distinct polymeric sequence of the array is typically present as a composition of multiple copies of the polymer on a substrate surface, e.g., as a spot or feature on the surface of the substrate. The number of distinct polymeric sequences, and hence spots or similar structures, present on the array may vary, where a typical array may contain more than about ten, more than about one hundred, more than about one thousand, more than about ten thousand or even more than about one hundred thousand features in an area of less than about 20 cm² or even less than about 10 cm². For example, features may have widths (that is, diameter, for a round spot) in the range from about 10 μm to about 1.0 cm. In other embodiments, each feature may have a width in the range from about 1.0 μm to about 1.0 mm, usually from about 5.0 μm to about 500 μm and more usually from about 10 μm to about 200 μm. Non-round features may have area ranges equivalent to that of circular features with the foregoing width (diameter) ranges. At least some, or all, of the features are of different compositions (for example, when any repeats of each feature composition are excluded, the remaining features may account for at least about 5%, 10%, 20% or more of the total number of features). Interfeature areas will typically (but not essentially) be present which do not carry any polynucleotide (or other biopolymer or chemical moiety of a type of which the features are composed). Such interfeature areas may be present, for example, where the arrays are formed by processes involving drop deposition of reagents, but may not be present when, for example, photolithographic array fabrication process are used. It will be appreciated though, that the interfeature areas, when present, could be of various sizes and configurations. The spots or features of distinct polymers present on the substrate surface are generally present as a pattern, where the pattern may be in the form of organized rows and columns of spots, e.g. a grid of spots, across the substrate surface, a series of curvilinear rows across the substrate surface, e.g. a series of concentric circles or semi-circles of spots, and the like.

In the broadest sense, the chemical arrays are arrays of polymeric or biopolymeric ligands or molecules, i.e., binding agents, where the polymeric binding agents may be any of: peptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like.

The arrays may be generated on the surfaces of the prongs using any convenient protocol. Various methods for forming arrays from pre-formed probes, or methods for generating the array using synthesis techniques to produce the probes in situ, are generally known in the art. For example, in situ fabrication methods are described in U.S. Pat. No. 5,449,754 for synthesizing peptide arrays, and in U.S. Pat. No. 6,180,351 and WO 98/41531 and the references cited therein for synthesizing polynucleotide arrays. Further details of fabricating biopolymer arrays are described in U.S. Pat. No. 6,242,266, U.S. Pat. No. 6,232,072, U.S. Pat. No. 6,180,351, and U.S. Pat. No. 6,171,797. Other techniques for fabricating biopolymer arrays include known light directed synthesis techniques. Methods for sample preparation, labeling, and hybridizing are disclosed for example in U.S. Pat. No. 6,201,112, U.S. Pat. No. 6,132,997, U.S. Pat. No. 6,235,483, and U.S. patent publication 20020192650. For example, probes can either be synthesized directly on the surfaces of the prongs or pre-made probes may be attached to the prongs. Arrays may be generated on prong surfaces using drop deposition from pulse jets of either polynucleotide precursor units (such as monomers) in the case of in situ fabrication, or the previously obtained polynucleotide (see for example U.S. Pat. Nos. 6,242,266, 6,232,072, 6,180,351, 6,171,797, and 6,323,043; and U.S. patent application Ser. No. 09/302,898 filed Apr. 30, 1999 by Caren et al.,). Other drop deposition methods may be used for fabrication. Also, instead of drop deposition methods, photolithographic array fabrication methods may be used such as described in, for example, U.S. Pat. Nos. 5,599,695, 5,753,788, and 6,329,143. Interfeature areas need not be present, particularly when the arrays are made by photolithographic methods as described in those patents.

A variety of solid supports may be used, upon which one or more chemical arrays may be positioned. The subject invention includes devices that include supports in the form of a base or foundation structure supporting a plurality of prongs. In certain embodiments, a plurality of arrays may be stably associated with one substrate, e.g., one or more prongs of a multi-prong device. For example, a plurality of chemical arrays may be stably associated with one base, where the arrays may be spatially separated from some or all of the other arrays associated with the base such as by being positioned on different prongs of the same base or, if positioned on the same prong, separated by inter-array regions that lack any arrays.

The substrate devices, e.g., supports in the form of a base structure supporting a plurality of prongs, upon which the arrays are generated may be selected from a wide variety of materials including, but not limited to, natural polymeric materials, synthetic or modified naturally occurring polymers and the like, such as poly (vinyl chloride), polyamides, polyacrylamide, polyacrylate, polymethacrylate, polyesters, polyolefins, polyethylene, polytetrafluoro-ethylene, polypropylene, poly (4-methylbutene), polystyrene, poly(ethylene terephthalate), nylon, poly(vinyl butyrate), polyetheretherketone (PEEK), and the like; either used by themselves or in conjunction with other materials; fused silica (e.g., glass), bioglass, silicon chips, ceramics, metals, metal oxides, and the like. For example, substrates may include polystyrene, to which short oligophosphodiesters, e.g., oligonucleotides ranging from about 5 to about 50 nucleotides in length, may readily be covalently attached (Letsinger et al. (1975) Nucl. Acids Res. 2:773-786), as well as polyacrylamide (Gait et al. (1982) Nucl. Acids Res. 10:6243-6254), silica (Caruthers et al. (1980) Tetrahedron Letters 21:719-722), and controlled-pore glass (Sproat et al. (1983) Tetrahedron Letters 24:5771-5774). Embodiments include substrates made of thermoplastic material such as acrylonitrile butadiene styrene (ABS), polypropylene, PEEK, and the like. Oftentimes (though not always) overlaying a base of a first material such as a base of any one of the materials described above, may be one or more additional materials such as one or more of a light returning layer, optically transparent layer, and the like overlayed one on top of the other (see for example U.S. patent application Ser. No. 10/285,756 (publication no. 20040086869)). In such instances, the underlying material may be referred to as a precursor device in that the underlying or precursor material is subjected to one or more other processes such as overlaying it with one or more additional layers. Additionally, some or all of the base/prong device may be hydrophilic or capable of being rendered hydrophilic and/or some or all of the base/prong device may be hydrophobic or capable of being rendered hydrophobic. For example n certain embodiments all but the top surface (i.e., the array site surface) of a prong may be hydrophobic so as to maintain fluid at an array site at the top surface of a prong (which may be hydrophilic in certain embodiments). In certain embodiments, portions of a device may be hydrophilic and portions may be hydrophobic. In certain embodiments, a ring or hydrophobic barrier may surround the perimeter of the top surfaces of the prongs to facilitate the retention of fluid at the top surfaces and/or hydrophilic regions may be present on the top surfaces of the prongs which may include the entire surface area of the top surface of a given prong. The substrates may be flexible or rigid and in certain embodiments portions of a device may be flexible and portions may be rigid. The base structure and the prongs supported thereby may be the same materials or may be of different materials.

The substrate may be (or at least include a portion that is) derivitized, such that substrates used for the arrays of addressable probes may be (or may include) surface-derivitized glass or silica, or polymer membrane surfaces, as described in Maskos, U. et al., Nucleic Acids Res, 1992, 20:1679-84 and Southern, E. M. et al., Nucleic acids Res, 1994, 22:1368-73. Embodiments include a base/prong device having a base overlayed with a surface-derivitized glass layer or the like. For example, multi-prong devices may be made of a base of ABS, PEEK, polypropylene, or the like, and some or all of the device (the base and prongs or just the prongs) may include a layer of a surface-derivitized material on top of the base.

Each array may cover an area of less than 200 mm², 100 mm², or less than 50 mm², 20 mm², or less than 10 mm². For example, arrays present on a surface of a prong, e.g., a distal or top surface of a prong, may cover an area of less than 200 mm², 100 mm², or less than 50 mm², 20 mm², or less than 10 mm² on the prong's top surface. In embodiments wherein more than one chemical array is generated on a single prong top surface, such generated arrays may be spaced apart from one another by a distance at least two, three, or four times the average distance between features within the arrays.

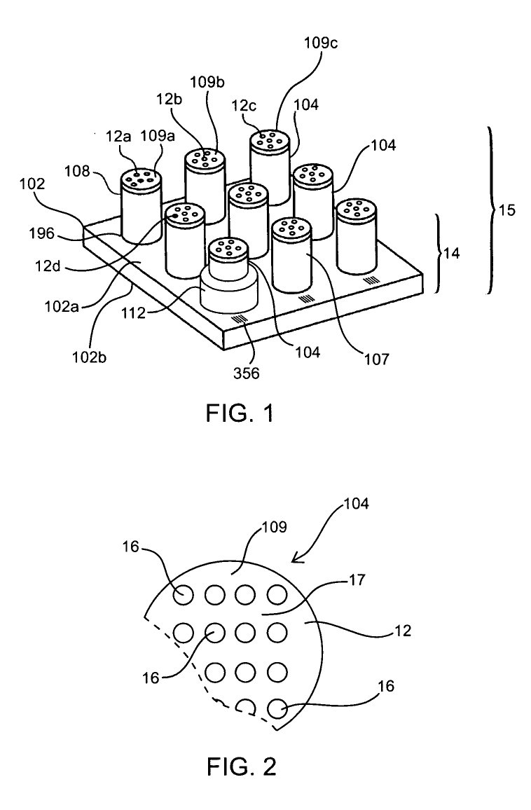

In many embodiments, base 102 (i.e., the foundation) supporting the prongs may be shaped generally as a rectangular solid (although other shapes are possible), having a length of more than about 4 mm and less than about 1 m, usually more than about 4 mm and less than about 600 mm, more usually less than about 400 mm; a width of more than about 4 mm and less than about 1 m, usually less than about 500 mm and more usually less than about 400 mm; and a thickness of more than about 0.01 mm and less than about 5.0 mm, usually more than about 0.1 mm and less than about 2 mm and more usually more than about 0.2 and less than about 1 mm. In certain embodiments, the base may have a length and width which is equal to that of any common laboratory sample device, such as no greater than about 150 mm or about 130 mm, by about 100 mm or about 90 mm, to allow compatibility with the well known standard 96, 384, or 1536 well microtiter plate format and/or apparatuses such as fluid handling devices, for use with such common standard laboratory devices. For example, the base 102 of assembly 15 of FIG. 1 may have length and width dimensions of about 7.62 cm by about 10.16 cm and may support ninety-six prongs arranged in a format of eight prongs by twelve prongs, e.g., in the same manner as wells of a standard ninety-six well microtiter plate. Each of the ninety-six prongs may carry a chemical array on a surface of the prong so as to provide ninety-six arrays arranged in an eight by twelve array format in the same manner as wells of a standard ninety-six well microtiter plate. As shown in FIG. 1, base 102 includes a first base surface 102a that includes prongs 104a, 104b, 104c . . . and a second base surface 102b that does not include prongs.

The prongs may have any suitable dimension or shape. For example, in certain embodiments prongs may have a height dimension as measured from the substrate surface 102a to the top surface 109 of a prong may range from about 1 mm to about 20 mm, e.g., from about 3 mm to about 15 mm, e.g., from about 5 mm to about 10 mm, where different prongs associated with the same base may have different heights.

With arrays that are read by detecting fluorescence, the substrate (base and/or prongs) may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least about 20%, or about 50% (or even at least about 70%, 90%, or 95%), of the illuminating light incident on the substrate as may be measured across the entire integrated spectrum of such illuminating light or alternatively at 532 nm or 633 nm.

The probes may be immobilized to a surface of the prongs using any suitable technique, including immobilizing pre-made probes and fabricating probes in situ, as will be described in greater detail below. A feature of the subject array assemblies is that the arrays are generated directly on the surfaces of the prongs, usually on the top or most distal surface of the prongs (i.e., the surface opposite the base-contacting surface of the prong). In other words, a device that includes a base and a plurality of prongs is operatively positioned relative to a fluid deposition device such as a syringe, fluid drop deposition device (e.g., a pulse jet fluid drop deposition device) or the like, and fluid for generating a chemical array is contacted with a surface of one or more prongs to immobilize a set of probes on the surface. The fluid may include pre-made probes or probe precursors such as nucleotides or the like for in situ probe synthesis or other chemistries used in array fabrication processes.

A portion of one embodiment of an array assembly 15 is illustrated in FIG. 1. The foundation structure of the embodiment illustrated includes a base 102 supporting a plurality of prongs 104 arranged in an x-y grid layout, although it is to be understood that other layouts are possible as well. A variety of different grid patterns and/or plate formats, which may have either a fixed or variable pitch, are contemplated by the subject invention. The spacing between the prongs may be any suitable spacing, where the minimum spacing between the prongs is only limited by the particular manufacturing process employed to manufacture the device, e.g., how small a device can be machined, molded, etc. Only a portion of base 102 is shown with a few prongs 104. In practice, base 102 may be more extensive and may support more than the nine prongs 104 illustrated, e.g., may support from about 1 to about 10000 prongs or more, e.g., from about 10 to about 5000 prongs, e.g., may support from about 40 to about 3000 prongs, e.g., may support 96 prongs in certain embodiments, may support 384 prongs in certain embodiments, and may support 1536 prongs in certain embodiments. Each prong 104 has a proximal end 196 attached to base 102 and a distal end 108 distally located from base 102. Distal end 108 provides at least one of the plurality of array sites on surface 109 which surface may be characterized as the top or distal-most surface of a base. It is to be understood that arrays may be generated on any surface of a base such a side surface 107 of a prong; however for convenience the subject invention is described primarily with respect to arrays generated on top surface 109 of a base where such description is not intended to limit the scope the invention. One or more chemical arrays may be generated on some or all of the plurality of prongs. In the figure, the distal end of the base is disc-shaped, although any conformation may typically be used, such as rectangular, square, polygonal, circular, or oval, i.e., prongs as well as the top surfaces thereof may be any suitable conformation and is not to be limited to the particular shapes shown in the figures.

Prongs 104 are shown regularly spaced and are positioned to correspond to wells in a multi-well plate, such as a 96-well (or 384-well, or 1536-well) microtiter plate, although other multi-well plates may be used, as well as other spacing formats. In certain embodiments, prongs 104 may be positioned to fit into every second, every third, or every fourth well in a multi-well plate such as a standard ninety-six well microtiter plate.

Top surfaces 109 of prongs 104 are typically (though not always) substantially flat (i.e., they may be planar surfaces) to facilitate the generation and scanning of chemical arrays thereon.

In certain embodiments, prongs 104 extend in a generally perpendicular direction from base 102, as illustrated in the figure; however, varying designs may have prongs 104 extending at an angle from base 102, e.g., the angle may range from about 75 to about 90 degrees, or possibly from about 60 to about 90 degrees, or even from about 45 degrees to about 90 degrees, or from about 30 degrees to about 90 degrees.

In certain embodiments, there may be a few (e.g., about 2, 3, 4, or up to about 10) “stopping” prongs, which may be situated at the corners or outer edges of the foundation. The stopping prongs may be slightly longer than remaining prongs in certain embodiments and may optionally lack chemical arrays (but also might be the same length or shorter, depending on the configuration of the mating part). These slightly longer stopping prongs may serve to provide a physical ‘stop’ when the array assembly is mated with a corresponding multi-well plate or the like, holding surfaces 109 of distal ends 108 of prongs 104 slightly above the bottom of the wells to prevent the array generated on surface 109 from contacting the bottom of the well. Alternatively, a few (e.g., about 2, 3, 4, or up to about 10) stopping prongs, which may be situated at the corners or outer edges of the foundation in certain embodiments, may be slightly shorter than remaining prongs and lack chemical arrays. These shorter stopping prongs are located so they do not correspond to the wells in a microtiter plate which may be associated with the multi-array device, but rather correspond to the top portion or surface of a multi-well plate or the like. These slightly shorter stopping prongs may serve to provide a physical ‘stop’ when the array assembly is mated with a corresponding multi-well plate, holding each of the arrays on the remaining prongs slightly above the bottom of the wells to prevent the array from contacting the bottom of the well. Embodiments may also include at least a few (e.g., about 2, 3, 4, about 10) of the prongs 104 themselves having a shape that includes a shoulder feature 112 that is a constituent of the prongs, i.e., in addition to the smooth cylindrical-shaped (for the prongs illustrated) portion of prongs 104, prongs 104 include a shoulder feature 112 extending radially from prong 104 at an appropriate distance to provide a stop to prevent the an array from contacting the bottom of a well. An embodiment of such a shoulder feature 112 is shown in FIG. 1. Note that the illustrated shoulder feature has a conical portion which serves as an aid in centering the prongs 104 in the wells of a multi-well plate, if so desired, and may also serves to retard evaporation from the wells during, e.g., during hybridization assays, by closing the open end of the well. Alternatively, the shoulder feature 112 may include a gasket or o-ring to retard evaporation and provide the stop. In certain embodiments, each of the prongs 104 may have such a shoulder feature 112. Alternatively, the base 102 may include a raised feature, e.g., a raised edge around the perimeter of the base, the raised feature providing the ‘stop’. In certain embodiments, no additional structural feature may be needed as the prongs may be of the appropriate length such that, if the array assembly is brought into functional relationship with a corresponding multi-well plate (e.g., in the performance of an array assay, the base butts against the multi-well plate providing the ‘stop’).

Array assembly 15 also includes at least one array of an addressable collection of probes 120 generated on a surface of the device 14 that includes base 102 supporting a plurality of prongs 104. As will be described in greater detail below, a feature of embodiments of the subject array assemblies is that the at least one addressable set of probes 12 is fabricated directly onto a surface of device 14 and usually on distal or top surface 109 of a prong 109 of device 14. In certain embodiments, a plurality of arrays 12a, 12b, 12c . . . , each of addressable sets of probes, may be generated on a single base/prong device. For example, two or more arrays may be generated on the same prong such that at least a first array and a second array may be generated on the same surface of a prong such as for example surface 109 of a prong and may be separated by inter-array areas. Embodiments also include arrays generated on different prongs of a base/prong device. For example, a first array 12a may be generated on a surface 109a of a first prong and a second array 12b may be generated on a surface of a second prong 104b. In those embodiments that include more than one array, at least one addressable collection of probes may be different from at least one other addressable collection of probes present on the same or different prong, such that different collections of probes may be generated on array assembly 15 and may be screened in parallel. Parallel in this context means that a plurality of array assays (e.g., hybridization assays) may be conducted at essentially the same time using the same or different sample. For example, a plurality of array assays may be conducted at essentially the same time wherein the assays may potentially be performed on sample solutions from different sources and/or may be potentially be done using different addressable collections of probes 12 (depending on the design of the array assembly).

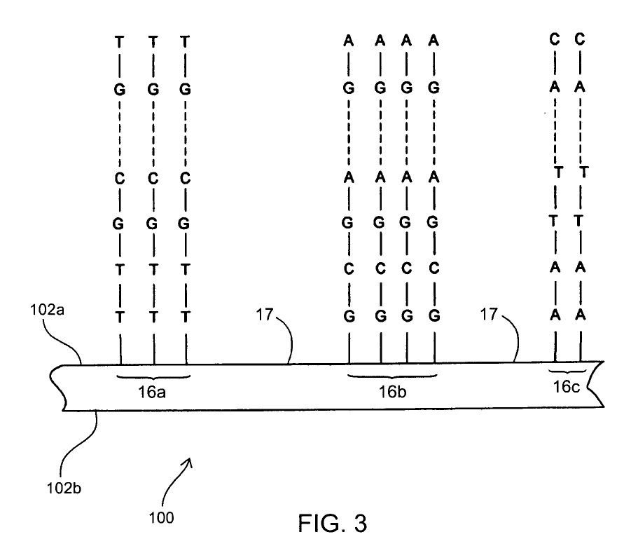

FIGS. 2 and 3 show views of a surface 109 of the array assembly 15 of FIG. 1 showing an addressable set of probes on the surface wherein FIG. 2 shows an enlarged view of a portion of surface 109 of a prong of FIG. 1 showing spots or features; and FIG. 3 is an enlarged view of a portion of surface 109 of FIG. 2. As shown, surface 109 of prong 104 includes an array 12 generated thereon. As noted above, while prong 104 is shown in this figure having only one addressable array generated on surface 109, it will be appreciated though, that more than one array (any of which are the same or different) may be generated on the same surface, with or without spacing between such arrays such that a given surface 109 of a prong 104 may include two or more arrays that may be the same or may be different. That is, any given array assembly may carry one, two, four or more arrays generated on the same or different prongs, depending on the use of the array assembly and any or all of the arrays may be the same or different from one another and each may contain multiple spots or features. For example embodiments may include 2n by 3n arrays on an array assembly, where n is some integer such as 4, 8, or 16, or more generally 4x where x is an integer from 1 to 5, 10, or 20 (for example, 5, 6, 7, 8, 9, 10, 11, 12 or 16). Accordingly, embodiments may include a device having a base supporting 2n by 3n prongs, where n is some integer such as 4, 8, or 16, or more generally 4x where x is an integer from 1 to 5, 10, or 20 (for example, 5, 6, 7, 8, 9, 10, 11, 12 or 16). In such embodiments, some or all of the 2n by 3n prongs may include one or more arrays generated thereon, where certain embodiments include 2n by 3n prongs and each prong has only one array generated on a surface thereof.

The one or more arrays 12 usually cover only a portion of surface 109, with regions of surface 109 not being covered by any array 12. Typically (though not necessarily) the sides 107 of a prong do not carry any arrays 12. In certain embodiments, the side surfaces of the prongs may be rendered hydrophobic to help maintain fluid at surface 109. Each array 12 may be designed for testing against any type of sample, whether a trial sample, reference sample, a combination of them, or a known mixture of biopolymers such as polynucleotides.

As mentioned above, array 12 contains multiple spots or features 16 of biopolymers, e.g., in the form of polynucleotides. Also as mentioned above, all of the features 16 may be different, or some or all could be the same. The interfeature areas 17 could be of various sizes and configurations. Each feature carries a predetermined biopolymer such as a predetermined polynucleotide (which includes the possibility of mixtures of polynucleotides). It will be understood that there may be a linker molecule (not shown) of any known types between surface 109 and the first nucleotide.

An array assembly may carry on its surface one or more identification codes 356, e.g., in the form of bar codes (not shown in this embodiment) or the like printed on a substrate in the form of a paper label attached by adhesive or any convenient means. Identifiers such as optical, radiofrequency identification (“RF ID”) tags or magnetic identifiers could be used instead of bar codes. An identification code may carry array layout information or an identification linked to array layout information in a remote or non-remote memory, for each array of the assembly which carries that identifier, as well as information on array features, all of which information may be used in a manner the same as described in U.S. Pat. No. 6,180,351. Multiple identifiers 356 may be carried on the base 102 and/or on one or more prongs 109. Each identifier may be associated with each array 12 by being on the same device and therefore having a fixed location in relation to identifier 356 from which relative location the identity of each array can be determined. The array assembly may further have one or more fiducial marks (not shown) for alignment purposes, for example during array fabrication and/or reading of the arrays, and the like.

As briefly noted above and which will be described in greater detail below, the present invention may be employed in an easy and high throughput manner in the exposing of the arrays to one or more different or same fluids, such as one or more fluid samples. For example, such may be accomplished automatically using automated systems and some or all of the arrays of the array assembly may be contacted with the same or different fluid at the same time, without cross contamination of fluids between the arrays.

Methods of Fabricating Multi-Prong Array Assemblies

The subject invention also provides methods for fabricating the multi-prong array assemblies of the subject invention and includes generating one or more chemical arrays on a surface of one or more prongs. As noted above, a feature of embodiments of the subject methods is that a chemical array is generated directly on a surface of a prong, e.g., directly on the distal surface 109 of a prong. For convenience, the subject methods are described primarily with respect to generating one array of an addressable set of probes on top surface 109 of one prong of a multi-prong device, where such description is not intended to limit the scope of the invention. It is to be understood that the subject methods may include generating two or more arrays on the surface of the same prong as well as generating two or more arrays on the surfaces of two or more different prongs, where the arrays may be the same or different.

In generating an addressable chemical array on a surface of a prong of a device that includes a base structure supporting a plurality of prongs, such a base/prong device is provided and operatively positioned to receive a fluid for array generation onto a surface thereof. The base/prong device may be provided pre-made, e.g., made a site other than the site of array fabrication, or may itself be fabricated at the site of array fabrication, e.g., as part of an array fabrication process, e.g., the fabrication of the base/prong device itself may be one or more steps in a continuous array manufacturing process or the like.

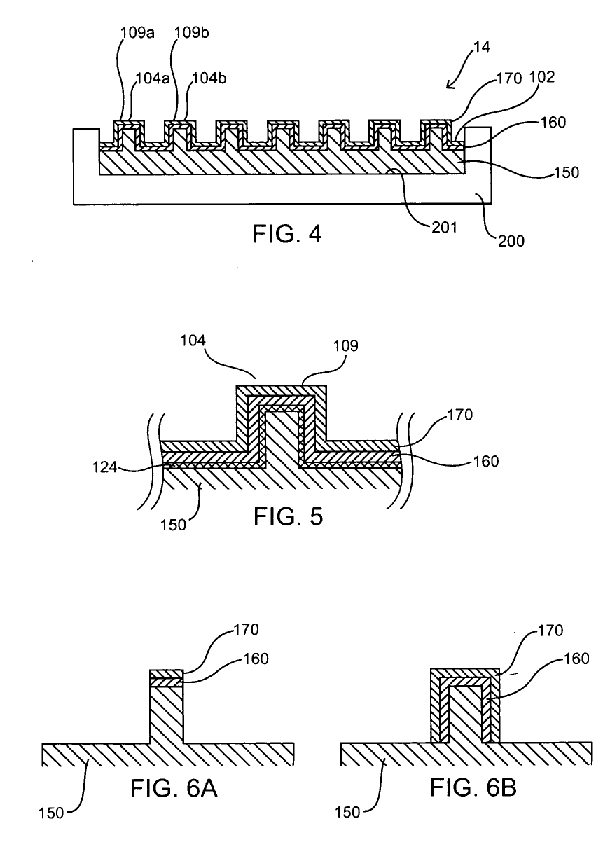

FIG. 4 shows a cross-sectional view through a base/prong device 14 that includes a base 102 supporting a plurality of prongs 104, such as device 14 of FIG. 1. Device 14 is shown removably positioned in optional rigid carrier 200 which may be used to facilitate moving and operatively positioning device 14 during array fabrication, e.g., used with an automated system. Rigid carrier may also include fiducial marks (not shown) which may be used in the positioning of device 14 during manufacturing of the array assembly. The rigid carrier may also include an identifier, e.g., a barcode or the like, which may include information relating to the manufacturing process. Device 14 may be held in place in carrier 200 by any suitable technique, e.g., the device may be snap fit, friction fit, held in place with clamps, adhesives, and the like. Rigid carrier 200 includes surface 201 that is substantially flat. Substantially flat surface 201 facilitates holding device 14 in an even manner for array fabrication and array scanning (when employed for such). This flatness may be important during the array fabrication if, for example, a method is used that deposits fluid from a fluid drop deposition device surface such as a pulse jet onto the substrate. Where such methods are used, a substrate surface that is substantially flat reduces trajectory errors and improves droplet control. Substrate flatness may also be important during scanning of a chemical array after an array assay. In scanning, a flat surface is helpful to maintain the array features within the focal plane of the scanner.

Embodiments of device 14 include at least a base 150. The base may be fabricated by methods well known in the art, including photolithographic processes, wet or dry chemical etching, laser ablation, or traditional machining. Other possible methods of fabrication include injection molding, hot embossing, casting, or other processes that utilize a mold or patterned tool to form the structural elements of the device, e.g., the base and prongs of the device. Any suitable material or materials may be used in fabrication of the base such as those described above. For example, material(s) including, but not limited to, material such as polymer, glass, silicon, metal, metal oxide, ceramic, and the like. A polymer such as polyimide polymethylmethacrylate (PMMA), polyproylene, polyethylene, polymethylpentene, polyetheretherketone (PEEK), polyimide, ABS, any of the fluorocarbon polymers or other suitable thermoplastic polymer, may be used for the construction of base 150. The material of the base may be selected to provide stable dimensional, mechanical, and chemical properties under the conditions device 14 may be used. The selection of materials that have suitable chemical properties are especially important if the device does not include optional layers 160 or 170 described below, since these layers may provide chemical resistance to the base. Thermal performance is important because polynucleotide arrays supported by the device may be subject to elevated temperatures (for example, about 60° C.) for long periods of time (for example, about 12 hours) in aqueous environments. Conditions for producing surface modifications on the device may require high temperatures (over 200° C.).

Embodiments of device 14 may also includes an optional light returning layer 160 and/or an optional optically transparent layer 170 (e.g., in the form of a glass layer or the like), where certain embodiments include both light returning layer 160 and optically transparent layer 170, or at least include optically transparent layer 170. Accordingly, a plurality of features 16, optionally separated from each other by interfeature areas, may be generated directly onto the outer-most material present at top surface of a prong, e.g., a top surface of base 150 (the top surface of a prong of base 150) if optional layers are not provided overlying the base, or a plurality of features 16, optionally separated from each other by interfeature areas, may be generated on a top surface of optional layer 160 (if layer 170 is not provided) or a top surface of layer 170. In certain embodiments, a base/prong device that includes a base in the form of a base supporting a plurality of prongs is overlayed with a contiguous layer such as a light returning layer which is in turn overlayed with a contiguous layer such as an optically transparent layer (e.g., glass layer) and an addressable set of probes, such as an addressable set of nucleic acid probes, is generated directly onto a the transparent layer at an area of the top surface of a prong. In certain embodiments, a base/prong just overlayed with a single contiguous layer such as an optically transparent layer (e.g., glass layer) and an addressable set of probes, such as an addressable set of nucleic acid probes, is generated directly onto a the transparent layer at an area of the top surface of a prong.

Light returning layer 160 may be any suitable reflective material, such as aluminum, silver, gold, platinum, chrome, tantalum, or other suitable metal or metal oxide film deposited by vacuum deposition, plasma enhanced chemical vapor deposition, sputtering, plating, or other means onto base 150 or onto an optional intermediate bonding layer 124. Alternatively, the light returning layer 160 may be constructed using multiple dielectric layers designed as a dielectric Bragg reflector or the like. For example, such a reflector may be constructed by repeating ¼ wave thick layers of two optically clear dielectrics which have differing indices of refraction. Design considerations for such a reflector include the excitation and emission wavelengths and the angle of incidence for the excitation beam and detector. To increase the reflectivity of the Bragg reflector, a metal layer may support the multiple dielectric layers such that the light returning layer comprises a metal layer and multiple dielectric layers. Bonding layer 124, if used, may be any suitable material which bonds to both base 150 and light returning layer 160.

Light returning layer 160, and optional bonding layers 124, may each have a thickness of less than about 250 nm, or even less than about 50, about 20, about 10, about 5 or about 1 nm, but in certain embodiments, for example, more than about 0.1 or about 0.5 nm). In one example, bonding layer 124 may be about 10 nm thick. Light returning layer 160 may be chosen to have a thickness such that it is opaque to the wavelength of the light used for illuminating the features during array reading. In particular embodiments, light returning layer 160 may be less than about 1750 nm thick and may be at least about 40 nm thick. In certain embodiments, light returning layer 160 may be less than about 750 nm thick and may be at least about 325 nm thick. Glass layer 170 may have a thickness and transparency selected as described in U.S. patent application Ser. No. 09/493,958 titled “Multi-Featured Arrays With Reflective Coating” filed Jan. 28, 2000 by Andreas Dorsel et al, while light returning layer 160 may meet the reflectivity requirements in relation to the illuminating light as mentioned in that application. For example, light returning layer 120 may reflect at least 10% of the incident light, or at least 20%, 50%, 80% or at least 90%, or even at least 95%, of the incident light. However, the glass layer and light returning layers may not meet those requirements.

Optically transparent layer 170 (such as a glass layer (which term is used to include silica)) may be deposited onto light returning layer 120 by vacuum deposition, sputtering, plating, plasma enhanced chemical vapor deposition or similar techniques such as are known in the art. An optional bonding layer may be provided between layer 170 and the material to which it is overlayed. As noted above, glass layer 170 may optionally be used without light returning layer 160. Glass layer 160 may have any suitable thickness. As noted above, glass layer 170 may have a thickness and transparency selected as described in U.S. patent application Ser. No. 09/493,958 titled “Multi-Featured Arrays With Reflective Coating” filed Jan. 28, 2000 by Andreas Dorsel et al. For example, in certain embodiments, the optically transparent layer may have a thickness that is greater than about 1, about 10 or about 100 nm, and less than about 1000, about 700, or about 400 nm but in certain embodiments has a thickness about ¼ wavelength of the light used to illuminate array features during reading, or an odd multiple of that amount. For example, 40 to 200 nm, or 60 to 120 nm (or even 80 to 100 nm), or an odd integer multiple of any of the foregoing thickness ranges (for example, 300 nm may be used).

In the above configuration of device 14, the use of an optically transparent layer such as a glass layer 170 allows the use of conventional chemistries for substrate coating, feature fabrication, and array usage (for example, conditions used for performing hybridization assays). Such chemistries are well known for arrays on glass substrates, as described in the references cited herein and elsewhere. However, other transparent materials may be used. Furthermore, using light returning layer 160 not only can provide the useful characteristics mentioned in the above referenced patent application Ser. No. 09/493,958, but can avoid undesirable optical characteristics of the base 150 (for example, undesirable fluorescence, and in the case of a base that absorbs the incident light energy, excessive heating and possible melting of the plastic material forming the base). The light returning layer 160 allows for the ability to use a material for the base 150 that may have a high fluorescence and/or high absorbance of incident light. For example, the plastic material used in the base 150 may have a fluorescence of at least five or ten (or even at least: twenty, fifty, one-hundred, or two-hundred) reference units, and/or an absorbance of the illuminating light used to read arrays 112 of at least 5%, 10%, 20%, or 50% (or even at least 70%, 90% or 95%).

Use of a non-reflective opaque layer (for example, a suitably dyed plastic or other layer) in place of light returning layer 160 also allows the use of the foregoing materials for the base although in such a case some heat may then be generated in the opaque layer. A light returning layer 160 or a non-reflective opaque layer disposed between the base and the optically transparent layer (e.g., glass layer 170), may block at least about 2% to about 100%, e.g., 10% or more (or even at least about 20%, about 50%, about 80%, about 90% or about 95%) of the illuminating light incident on the glass layer 170 from reaching the base 150. A non-reflective opaque layer may reflect less than about 100%, 95%, about 90%, about 80%, or about 50% (or even less than about 10% or even less than about 2%) of the illuminating light. Where neither a light returning layer nor an opaque layer is present, a base 150 that emits low fluorescence upon illumination with the excitation light may be employed, at least in the situation where the array is read by detecting fluorescence. The base 150 in this case may emit less than about 200, about 100, about 50, or about 20 (or even less than 10 or 5) reference units. Additionally in this case, the base may be relatively transparent to reduce the absorption of the incident illuminating laser light and subsequent heating if the focused laser beam travels too slowly over a region. For example, the base may transmit at least about 2% to about 100%, e.g., about 5%, about 10%, about 20%, or 50% (or even at least about 70%, about 90%, or about 95% or more), of the illuminating light incident on the optically transparent layer. Note that all reflection and absorbance measurements herein, unless the contrary is indicated, are made with reference to the illuminating light incident on the optically transparent layer for reading arrays 12 and may be measured across the entire integrated spectrum of such illuminating light or alternatively at 532 nm or 633 nm or other suitable wavelength depending on the conditions used for performing the array binding analyses.

Accordingly, methods may include fabricating a base/prong device 14 by providing reflective and optically transparent layers directly on a base in a high throughput manufacturing process. As FIG. 5 shows in the enlarged view of a portion of device 14 of FIG. 4, layers 160 and 170 overlying 150 base are in the form of contiguous pieces of material overlying the base (the layers are present about the prongs and in between the prongs), e.g., by employing chemical vapor deposition processes or the like as noted above. In other words, all surfaces of the base 102 may be overlayed or covered with one or more contiguous layers. A uniform coating of the entire base, as well as prongs, with a reflective coating or any such base coating upon which the features are directly generated may serve to protect the base from degradation, e.g., if laser energy from a chemical array scanner used to read the array happens to come in contact with the base. Furthermore, such a coating may also serve to protect underlying material from chemical attack. By overlaying or covering surfaces of the base with one or more contiguous layers, no alignment step is needed to precisely position remotely fabricated layers (already having arrays thereon) onto the prongs as the subject invention provides novel methods of fabricating a base 150 with material(s) of interest (layers 160 and/or 170) directly onto the base and generating arrays directly onto surfaces of the prongs, i.e., the steps of remotely fabricating layers having arrays already on them and then precisely positioning such layers on the tops of the prongs are eliminated by the subject invention.

In certain embodiments, a portion of the material of layers 160 and/or 170 (if both are present) may be removed from device 14. For example, material may be removed as shown in FIGS. 6A and 6B wherein FIG. 6A shows layers 160 and 170 removed from all areas except top surface 109 of the prong and FIG. 6B shows layers 160 and 170 removed from the areas in between the prongs, but remaining on side surface 107 and top surface 109 of the prong. The top surfaces of the prongs will include suitable material, as describe above, to provide a suitable surface upon which chemical arrays may be fabricated and a suitable surface for scanning chemical arrays with an array scanner. However, while it may be advantageous not to remove layer 160 and/or 170 from the other areas of the device, e.g., to provide chemical resistance, in certain embodiments layer 160 and/or 170 may be removed from areas other than the top surfaces of the prongs. This removal of material may be accomplished using any suitable technique where the particular method employed will depend on a variety of factors such as the particular material to be removed and the like. Any suitable physical and/or chemical method may be employed. For example, portions of the device may be masked and the unmasked areas may be subjected to physical and/or chemical treatments that serve to remove certain material from the unmasked areas, e.g., in a predetermined, controlled manner. Removal methods include, but are not limited to, wet etching (removing material by contacting the material with a chemical solution), dry etching (material is sputtered or dissolved using reactive ions or a vapor phase etchant), laser scribing, and the like.

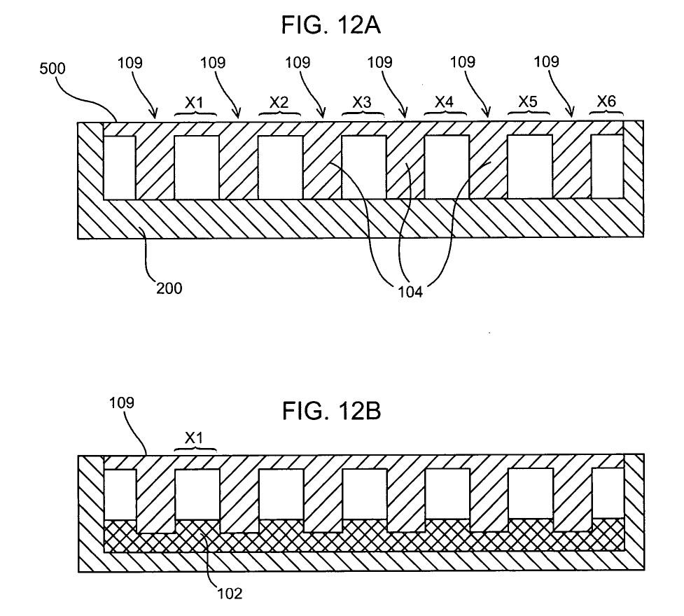

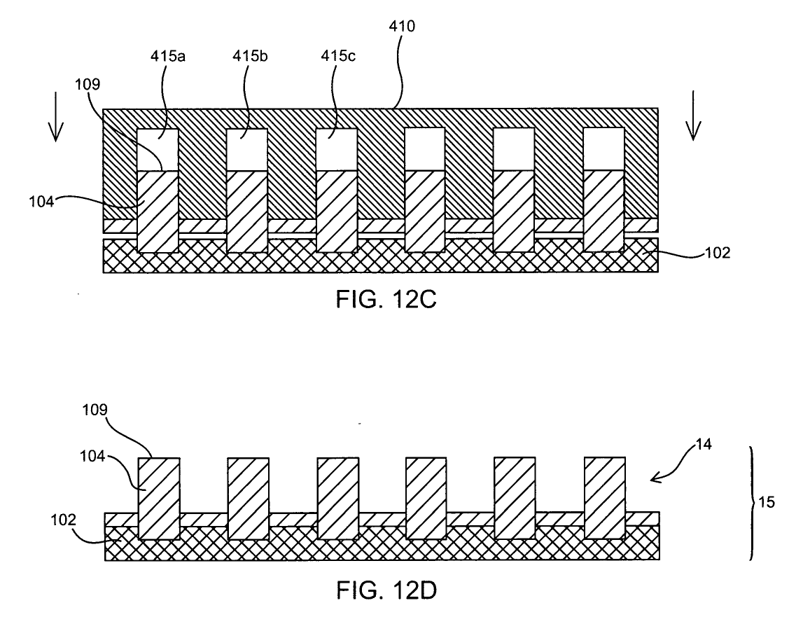

As mentioned above, in certain embodiments a substantially flat prong surface is desired to facilitate the printing and wetting processing of chemical arrays on the surface, as well as to facilitate scanning of the chemical arrays. It may be desirable to block the areas between the prongs so that fluid intended to be deposited at the prong surfaces is not unintentionally deposited on areas other than the prongs surfaces such as areas between the prong surfaces. Accordingly, it may be desirable to seal the prong surfaces during array fabrication or stated otherwise provide a barrier around the prong surfaces so that fluid is maintained at the prong surfaces during array fabrication. One manner of providing a substantially flat, sealed prong surface includes using a web of material co-planar with the tops of the prong surfaces (which may have one or more layers as described above). The material of the web may be the same material as the prongs and/or base supporting the prongs and may be molded as one piece with the prongs. This method is further described with reference to FIGS. 12A-12D.

As shown in the cross-sectional view of FIG. 12A, a one-piece basestructure 500 is provided that includes basea plurality of prongs 104 interconnected by inter-prong portions X1, X2, X3, etc., such that structure 500 is a contiguous web of material in that inter-prong areas X1, X2, X3, etc., are in-between the prongs of the structure. In this manner, the fluid is blocked from contacting the areas between the prongs (e.g., the sides of the prongs which is particularly advantageous when fluid is contacted with the prongs in a flow chemistry process or other process or the like, e.g., using a flow cell process or the like. As described in greater detail below, a flood chemistry process or the like may be used for some or all steps of array fabrication. For example, a flood chemistry process may be used in which a base/prong device may be repeatedly positioned with respect to a fluid drop deposition head such as a pulse jet head for certain steps of array fabrication, in between which the device may be immersed in liquid chemistries, e.g., when it is appropriate to contact the surfaces of all of the prongs with the same fluid. This process may be repeated one or more times to generate probes on the surfaces of the prongs. Accordingly, structure 500 may improve the fluid flow across the top surfaces of the prong, e.g., in instances in which it is appropriate to contact the surfaces of all of the prongs with the same fluid. In an alternative embodiment a fluid contacting plate may be used in an analogous manner, as described in greater detail below.

Structure 500 is shown removably positioned in optional rigid carrier 200 in FIG. 12A. In certain embodiments, the prongs may be supported by a base 102 as shown in FIG. 12B, which in turn may be positioned in optional rigid carrier 200, where the prongs may be secured to the base in any suitable manner as described above, e.g., pres fit, snap fit, friction fit, adhesively secured, cemented, etc. The one or more chemical arrays may be generated on the substantially flat surfaces 109 of the prongs.

Once the arrays are generated on the top surfaces of the prongs, the inter-prong areas X1, X2, etc., (the portion of structure 500 that resides in between the prongs) may now be removed away from the top surfaces of the prongs. In certain embodiments as shown in the partial view of FIG. 12C, a cutter 410 such as a punch tool or the like, having a plurality of receptacles 415a, 415b, 415c, etc., corresponding to the prongs of structure 500 may be brought into position relative to structure 500 (for example in the direction of the arrows of FIG. 12C) and each prong of device 14 may be pushed into a respective receptacle of cutter 410, thereby shearing away the material between the prongs X1, X2, X3, etc. The areas X1, X2, X3, etc., is thus sheared and pushed down around the sides of the prongs as shown in FIG. 12C. Regardless of the particulars of how the structure is cut to remove inter-prong portions, the result is shown in FIG. 12D which shows a base/prong device 14 as described above having one or more chemical arrays on the surfaces of the prongs to provide a base/prong array assembly, as described above.

Once a multi-prong base device is provided, direct immobilization of probes to the surface of one or more prongs may be performed in any suitable manner. Immobilization of the probe to a substrate may be performed using conventional techniques. See, e.g., Letsinger et al. (1975) Nucl. Acids Res. 2:773-786; Pease, A. C. et al., Proc. Nat. Acad. Sci. USA, 1994, 91:5022-5026, and “Oligonucleotide Synthesis, a Practical Approach,” Gait, M. J. (ed.), Oxford, England: IRL Press (1984). The surface of a substrate may be treated with an organosilane coupling agent to functionalize the surface. See, e.g., Arkins, A Silane Coupling Agent Chemistry,” Petrarch Systems Register and Review, Eds. Anderson et al. (1987) and U.S. Pat. No. 6,258,454. For example, in certain embodiments silyation may be accomplished by immersing the entire base/prong device is the suitable chemistries to functionalize the surface. Functionalizing the entire device may also prevent or at least minimize the amount of unwanted by-products, such as plasticizers, which may be detrimental to the quality or performance of the end product

Various methods for forming arrays from pre-formed probes, or methods for generating the array using synthesis techniques to produce the probes in situ, are generally known in the art, as noted above. For example, probes can either be synthesized directly on the surfaces of the prongs or directly attached to the prongs after the probes are made. Arrays may be fabricated using drop deposition from pulse jets of either polynucleotide precursor units (such as monomers) in the case of in situ fabrication, or the previously obtained polynucleotide. Such methods are described in detail in, for example, the previously cited references including U.S. Pat. Nos. 6,242,266, 6,232,072, 6,180,351, 6,171,797, and 6,323,043; and U.S. patent application Ser. No. 09/302,898 filed Apr. 30, 1999 by Caren et al., and the references cited therein, the disclosures of which are herein incorporated by reference. Other drop deposition methods may be used for fabrication. Also, instead of drop deposition methods, photolithographic array fabrication methods may be used such as described in U.S. Pat. Nos. 5,599,695, 5,753,788, and 6,329,143, the disclosures of which are herein incorporated by reference. As mentioned above, interfeature areas need not be present, particularly when the arrays are made by photolithographic methods as described in those patents.

In certain embodiments, one or more of the above-described manufacturing steps may employ a fluid contacting plate that includes a planar support having a plurality of holes shaped complementary to the prongs such that the fluid contacting plate may be operatively positioned relative to a base/prong device such that the holes of the fluid contacting plate may receive the prongs. The base/prong device may or may not already have probes generated thereon, depending on the process in which the fluid contacting plate is being used. For example, a fluid contacting plate may be used to functionalize a surface of the device prior to probe generation and/or may be used during probe generation on the prongs surfaces and/or may be used after probe generation such as in an array assay, etc.

The fluid contacting plates may be employed in methods of contacting fluid with a surface of a base/prong device, e.g., when fluid is contacted with a base/prong device using a flow cell or analogous apparatus, so that the fluid contacting plate serves to confine the contacted fluid to a defined area of the base/prong device (e.g., the top surface of the prongs). For example, a fluid contacting plate may be used in the generation of probes on a prong such that certain fluids used in the probe generation process are only contacted with certain regions of the prongs (the top surfaces of the prongs) and blocked from contacting other areas. The fluid contacting plates may also be used in the performance of an array assay such as for contacting of a fluid such as sample, wash fluid, etc.

In the broadest sense a fluid contacting plate may be described as a planar support that includes one or more holes or bores through the support. The holes may be configured to align with the prongs of a base/prong device when a base/prong device and fluid contacting plate are operatively positioned relative to each other to provide a fluid contacting structure that includes a base/prong device operatively mated with a fluid contacting plate. The fluid contacting plates can accommodate a wide range of prong formats, e.g., by configuring a given plate to correspond to a given prong configuration and/or by only utilizing certain holes of a plate to accommodate a particular prong format.

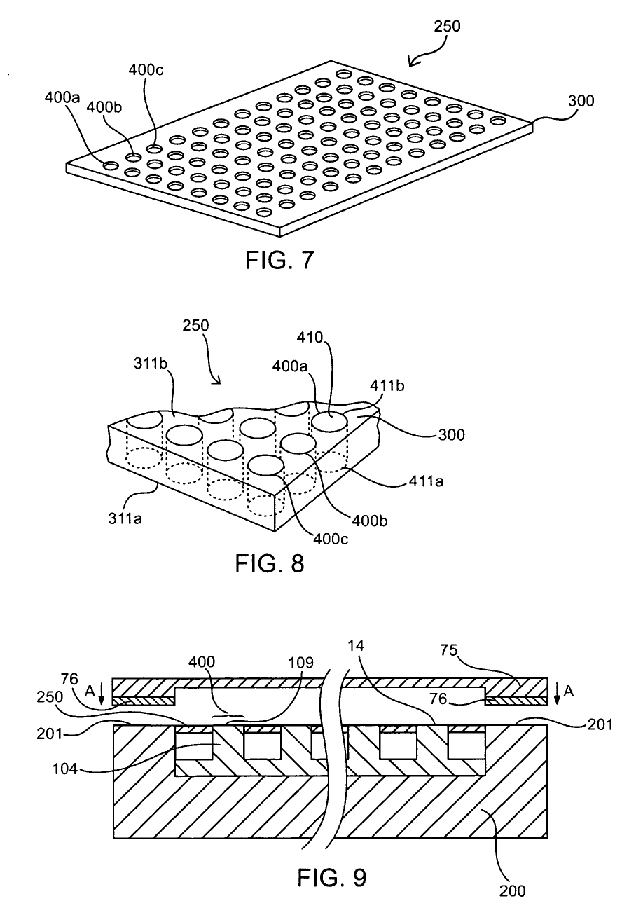

FIG. 7 shows an exemplary embodiments of fluid contacting plate plates 250 that include support 300 having one or more holes 400 that extend through the entire thickness of support 300. FIG. 8 shows a portion of fluid contacting plate 250 of FIG. 7. As shown in the figures, support 300 includes a first side 311a and a second side 311b that is opposite side 311a. The plate may assume a variety of shapes and sizes, where a given plate may be configured (e.g., sized, shaped, etc.) to be operatively positioned relative to a base/prong device so that a fluid may be contacted with a defined region of the base/prong device (e.g., the top surfaces of the prongs of the device) by introducing the fluid through one of the holes of the fluid contacting plate. In this manner, the inter-hole areas prevent or block fluid from contacting the areas between the prongs of the device (see for example FIG. 9.), as well as preventing cross contamination of fluids contacted with different prongs and may improve the fluid flow across the top surfaces of the prongs, for example, by making these combined surfaces substantially coplanar.

As noted above and as shown in the figures, each hole of the fluid contacting plate extends in a thickness dimension of the plate and each hole is open at both ends, i.e., the holes are through holes or bores through a plate, i.e., open channels or passages that extend through the plate. Each hole 400 has a side wall 410 adjacent to an open end 411a and at an opposite end adjacent to a second open end 411b. The first and second open ends, adjacent respective surfaces 311a and 311b of support 300, provide access to an operatively positioned base/prong assembly. For example, second open end 411b of a hole may be used to receive a volume of fluid to be contacted with the top surfaces of prong operatively received by the hole if surface 311b is higher than the top surface of the prongs. In such embodiments, the holes may be used to hold individual samples for contact to each, respective post. The cylindrical surface of a prong 104 may be tapered in certain aspects to enforce a snug, liquid-tight fit. In certain aspects, the inner diameter of hole 410 may include a sharp edge to deform the cylindrical surface of a prong 1 for a better seal and/or the inner diameter of a hole may include a deformable surface and/or may include a flexible, lip seal for sealing around a prong. A flat or tapered shoulder 112 can serve as either a registration surface and/or a sealing surface between the contacting plate and the base/prong device. There could be a “snap-fit” between the two parts to hold them together.

The number of holes of a fluid contacting plate may vary and may depend on the particular application with which the plate is used, the particular prong format with which it is used etc. The number of holes may range from about 1 to about 500 or more, e.g., 1 to about 100. In many embodiments, the number of holes roughly corresponds to, i.e., is the same as or similar to, the number of prongs of a base/prong device with which it is designed to be used. As such, if the base/prong device includes 1 prong, the plate may include 1 hole, if the base/prong device includes 10 prong, the plate may include 10 holes, if the base/prong device includes 96 prongs, the plate may include 96 holes, etc. For example, fluid handling plates may include 2n by 3n holes, where n is some integer such as 4, 8, or 16, or more generally 4x where x is an integer from 1 to 5, 10, or 20 (for example, 5, 6, 7, 8, 9, 10, 11, 12 or 16). The number of holes need not match exactly to the number of prongs with which it is to be used, and may be more or less. For example, it may not be desirable to contact all of the prongs with fluid at the same time, or the like, and as such a plate may be so configured to accomplish this.

The holes may be arranged in any suitable configuration and may be based at least in part on the particular base/prong device with which it is designed to be used etc. For example, holes may be present as a pattern, where the pattern may be in the form of organized rows and columns of spots, e.g. a grid of holes, across the plate, etc. A fluid contacting plate may be designed to be used with a base/prong device having an x-y grid pattern of prongs as described above, and thus the fluid contacting plate may have holes in the same or analogous grid pattern. For example, a plate may be designed to be used with base/prong device having prongs arranged in a grid pattern and thus the plate may include about 96 holes arranged in the same or analogous grid pattern as the 96 prongs with which it is intended to be used.

While the holes are shown as circular in the figures herein, the holes are not limited to any particular shape and may be square, rectangle, oval, etc., where the shape may be dependant at least upon the shape of the prongs with which the plate is intended to be used.

The plates may be made from any suitable material and are usually chosen with respect to the conditions to which the plates may be exposed, e.g., the conditions of any treatment or handling or processing that may be encountered in the use of the plates, e.g., probe generation, hybridization assays, protein binding assays, washings, etc. One or more materials may be used to fabricate the plates such that a plurality of materials may be employed. Examples of materials which may be used to fabricate the subject plates include, but are not limited to, metals such as stainless steel, aluminum, and alloys thereof; polymers, e.g., plastics and other polymeric materials such as poly (vinylidene difluoride), poly(ethyleneterephthalate), polyurethane, e.g., nonporous polyurethane, fluoropolymers such as polytetrafluoroethylene (e.g., Teflon®), polyimide, polypropylene, polystyrene, polycarbonate, PVC, and blends thereof; siliceous materials, e.g., glasses, fused silica, ceramics and the like. In many embodiments, the plates are constructed of elastomeric material, or may at least include elastomeric portions. The plates may be flexible or rigid or may include portions that are flexible and portions that are rigid. In certain aspects, the plates may be made of a plastic, or of an elastomer or a thermoplastic elastomer.

FIG. 9 shows a cross-sectional view through a portion of carrier 200 holding base/prong device 14 and a fluid contacting plate 250 operatively positioned relative to device 14 so as to provide fluid access to top surfaces 109 of prongs 104 while preventing or sealing-off fluid access to the areas surrounding top surfaces 109, thus preventing fluid from contacting these areas. In this manner, a flow cell or the like may be used to introduce fluid to the entire device (e.g., flush the device with fluid) while plate 250 permits the introduced fluid to only contact specific, defined regions of the prongs and prevents the introduced fluid from contacting other regions of the device. The fluid contacting plate may be maintained in operative position with respect to the prongs in any suitable manner, e.g., friction fit, snap fit, fasteners, clamps, spacers, and the like.

Once the surfaces of device 14 have been suitably prepared (e.g., functionalized, etc.), probes may be generated on the top surfaces of the prongs. A flow cell type process using a fluid contacting plate may be employed for some or all of the probe generation process, thereby ensuring that fluids used in the probe generation process are confined to array site areas. It is to be understood that a flow cell process is but one manner in which fluid may be contacted with a surface of a prong for array generation thereon. Any other suitable manual or automatic manner of contacting fluid with a substrate surface for array fabrication may be used and include, but are not limited to, pipetting, and the like. As mentioned above, a fluid contacting plate may be used in an array assay in analogous manner, e.g., for contacting fluid to arrays generated on the prong surfaces, thereby confining the fluid to the areas of the arrays. In this manner, if the contacted fluid is sample (which is oftentimes rare and expensive), the sample is thus conserved. Furthermore, the amount of fluid contacted with a given array area will be easily controlled if confined to the planar surface.

As shown in FIG. 9, in use a flow cell 75 may be placed in contact with the base/prong device that has been previously associated with a fluid contacting plate, such that, the flow cell may be brought into position, e.g., lowered down onto the structure in the direction of the arrows A, such that the flow cell sealing elements 76, which may be o-rings or any other suitable gasket, or the like, seal at the contacting surface (surface 201) of carrier 200 to provide a fluid tight seal about device 14.

A flow cell arrangement may be used for some or all steps of array fabrication. For example, a recirculating flow cell format may be used For example, device 14 may be repeatedly positioned with respect to a fluid drop deposition head for certain steps of array fabrication, in between which device 14 may be positioned in a flow cell type arrangement, e.g., when it is appropriate to contact the surfaces of all of the prongs with the same fluid. This process may be repeated one or more times to generate probes on the surfaces of the prongs.

For example, probes may be generated on a prong surface by in situ synthesis, e.g., which may be carried-out by way of highly automated methods such as methods that employ pulse-jet fluid deposition technology in which thermal or piezo pulse jet devices analogous to inkjet printing devices are employed to deposit fluids of biopolymeric precursor molecules, i.e., monomers, onto surfaces of the prongs. In those instances in which an in situ synthesis approach is employed, conventional phosphoramidite synthesis protocols may be used. In phosphoramidite synthesis protocols, the 3′-hydroxyl group of an initial 5′-protected nucleoside is first covalently attached to a prong surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. In this manner, a series of fluid droplets, each containing one particular type of reactive deoxynucleoside phosphoramidite is sequentially applied to each discrete array feature by a fluid drop deposition head. Accordingly, during fabrication of in situ oligonucleotide arrays, the oligonucleotide synthesis cycle may be spatially controlled to initiate synthesis and perform successive couplings at specific locations on a prong surface. Coupling of the phosphoramidites may be spatially controlled using fluid drop deposition technology or the like and the remainder of the steps, e.g., capping, oxidation, solvent washes, etc., may be performed in a flow cell such that, during the synthesis of each successive oligonucleotide layer, the base/prong device may be transferred, e.g., between a stage such as an XYZ stage of a spatially controlled reaction module for coupling and a non-spatially controlled reaction module for capping, oxidation, etc. A fluid contacting plate may be employed in the coupling steps and/or the remainder of the steps, e.g., capping, oxidation, solvent washes. In certain embodiments, a fluid contacting plate may be employed solely in the steps that are performed in a flow cell (e.g., capping, oxidation, solvent washes) and may thus be removed for the steps that are not performed in a flow cell such as the coupling steps.

Accordingly, in certain embodiments structure 500 may be used or a fluid contacting plate may only be used in certain steps of the probe generation process, e.g., it may be removed during others. For example, embodiments may include employing a fluid drop deposition device (e.g., a pulse-jet type device) for contacting certain probe generation fluids (e.g., fluids of biopolymeric precursor molecules, i.e., monomers, or the like in the case of in situ probe generation) with the prong surfaces of a base/prong device and a flow cell or other analogous apparatus for contacting certain other probe generation fluids (e.g., for oxidation, capping, etc.) with the base/prong device. In such embodiments, a base/prong device may be transferred between the fluid drop deposition device and the flow cell type device one or more times during the generation of one or more arrays on one or more prongs of the device. A fluid contacting plate may be operatively positioned relative to a base/prong device and used during the flow cell operations and removed and thus not used during the fluid drop deposition operations, which positioning and removal may be repeated one or more times during the course of array fabrication. Embodiments may also include using a fluid contacting plate during fluid drop deposition operations and during flow cell operations. Of course, it is envisioned that embodiments may include using a fluid contacting plate just during fluid drop deposition operations and not for flow cell type operations (if any) or a fluid contacting plate may not be used at all.

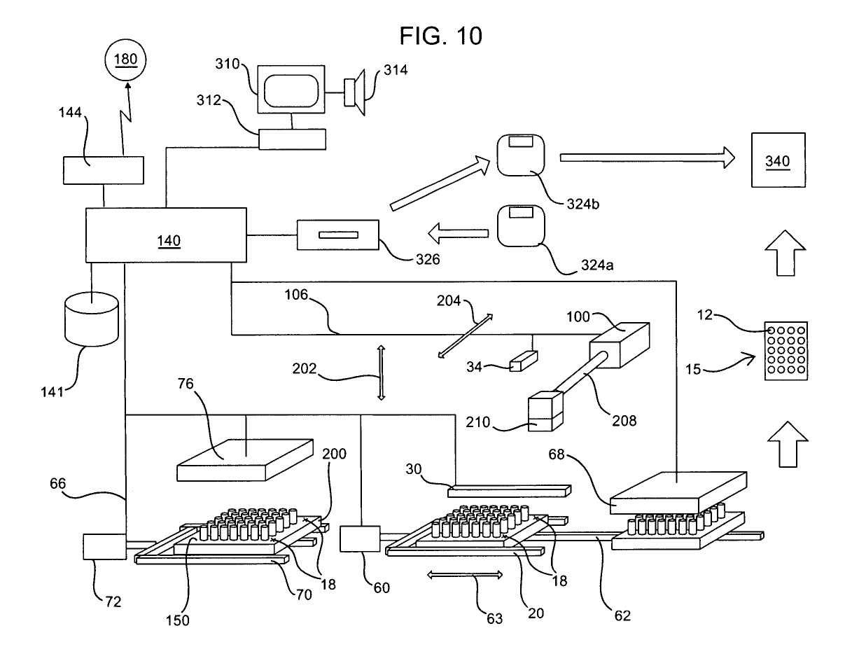

The array fabrication methods of the subject invention may be partially or completely automated. For example, an automated system as illustrated in FIG. 10 may be employed. As such, the subject methods are amenable to high throughput applications.

One such automated system that may be employed in the practice of the subject methods is described with reference FIG. 10, which shows an apparatus capable of executing a method of the present invention. The below-described general array fabrication apparatus configured to generate arrays directly on the top surfaces of prongs of base/prong devices to provide array assemblies as described above may be used to fabricate arrays in which the desired previously obtained moieties are directly deposited at the desired locations on prongs 104 (such as the deposition of polynucleotides), or may be used to synthesize the desired moieties (such as polynucleotides) in an in situ synthesis method such as described above for the in situ synthesis of polynucleotides on an array. Certain embodiments include an automated fluid deposition apparatus under the control of a processor which may be programmed to control the contacting of fluid at different prongs in parallel or independently.

The apparatus shown essentially has two sections, a first, optional section for fabricating a base/prong device 14 (i.e., providing layers 160 and 170 over base 150) and a second section in which one or more arrays are generated on a surface one or more prongs of the device, which surfaces may be functionalized surfaces. A third optional section (not shown) may also be included on which a surface of device 14 may be functionalized if desired. While the sections are shown as part of one apparatus in FIG. 10, it will be appreciated that they may be entirely separate with the first section preparing many base/prong devices (and an optional section then preparing many functionalized devices) which may be forwarded to the fabrication section for array generation on prong surfaces, with their possibly being one or more first sections and one or more second sections remote from each other.

base As noted above, the apparatus of FIG. 10 includes array fabrication station 20 on which device 14 may be mounted and retained. At this station, one or more addressable sets of probes are generated directly onto one or more prongs of a multi-prong device such that fluid may be contacted with different prongs at the same time or at different times, which contacting may be controlled by a processor configured to direct a fluid contacting device to perform this function. Pins or similar means (not shown) may be provided on station 20 by which to approximately align device 14 to a nominal position thereon (with optional alignment marks 18 on device 14 (and/or carrier 200 and/or top surfaces of the posts) being used for more refined alignment). Substrate station 20 may include a vacuum chuck connected to a suitable vacuum source (not shown) to retain device 14. An optional flood station 68 may be provided which can expose the appropriate surfaces of device 14, when positioned at station 68 as illustrated in broken lines in FIG. 10, to a fluid typically used in the in situ process, and to which all features must be exposed during each cycle (for example, oxidizer, deprotection agent, and wash buffer). In the case of deposition of a previously obtained polynucleotide, flood station 68 need not be present. A vacuum chuck or the like may transport device 14 between a fluid deposition station for array synthesis coupling and a flood station.

A fluid drop deposition system is present in the form of a dispensing head 210 which is retained by a head retainer 208. Head system 210 may contain one or more (for example, two or more) heads mounted on the same head retainer 208. Each such head may be of a type commonly used in an ink jet type of printer and may, for example, have one hundred fifty drop dispensing orifices in each of about two parallel rows, about six or more chambers for holding polynucleotide solution (or other derivatizing chemical) communicating with about the three hundred orifices, and about three hundred ejectors which may be positioned in the chambers opposite a corresponding orifice. Each ejector may be in the form of an electrical resistor operating as a heating element under control of processor 140 (although piezoelectric elements may be used instead). Each orifice with its associated ejector and portion of the chamber, defines a corresponding pulse jet with the orifice acting as a nozzle. In this manner, application of a single electric pulse to an ejector causes a droplet to be dispensed from a corresponding orifice. The foregoing head system 210 and other suitable dispensing head designs are described, e.g., in U.S. Pat. Nos. 6,461,812; 6,323,043; 6,599,693; the disclosures of which are incorporated herein by reference. However, other head system configurations can be used. Different orifices may be controlled by a suitably programmed processor to deposit the same or different fluids to different prongs of a base at the same or different times.

It should be understood though, that the present invention is not limited to pulse jet type deposition systems as part of the fabricator. In particular, any type of array fabricating apparatus may be used as the fabricator, including those such as described in U.S. Pat. No. 5,807,522, or apparatus which may employ photolithographic techniques for forming arrays of moieties, or any other suitable apparatus which may be used for fabricating arrays of moieties.

Accordingly, the head system may include more than one head 210 retained by the same head retainer 208 so that such retained heads move in unison together. The transporter system may include a carriage 62 connected to a first transporter 60 controlled by processor 140 through line 66, and a second transporter 100 controlled by processor 140 through line 106. Transporter 60 and carriage 62 are used to execute one axis positioning of station 20 (and hence mounted device 14) facing the dispensing head 210, by moving it in the direction of axis 63, while transporter 100 is used to provide adjustment of the position of head retainer 208 (and hence head 210) in a direction of axis 204. In this manner, head 210 can be scanned line by line along parallel lines in a raster fashion, by scanning along a line over device 14 in the direction of axis 204 using transporter 100, while line to line transitioning movement of device 14 in a direction of axis 63 is provided by transporter 60. Transporter 60 may also move substrate holder 20 to position device 14 in flood station 68 (as illustrated by the device 14 shown in broken lines in FIG. 10). Head 210 may also optionally be moved in a vertical direction 202, by another suitable transporter (not shown) and its angle of rotation with respect to head 210 also adjusted. It will be appreciated that other scanning configurations could be used during array fabrication. It will also be appreciated that both transporters 60 and 100, or either one of them, with suitable construction, could be used to perform the foregoing scanning of head 210 with respect to device 14. Thus, when the present application recites “positioning”, “moving”, or similar, one element (such as head 210) in relation to another element (such as one of the stations or device 14) it will be understood that any required moving can be accomplished by moving either element or a combination of both of them. The head 210, the transporter system, and processor 140 together act as the deposition system of the apparatus. An encoder 30 communicates with processor 140 to provide data on the exact location of station 20 (and hence device 14 if positioned correctly on station 20), while encoder 34 provides data on the exact location of holder 208 (and hence head 210 if positioned correctly on holder 208). Any suitable encoder, such as an optical encoder, may be used which provides data on linear position. Encoder 30 may provides device 14 location data by identifying the location of fiducials 18 on device 14 (and/or carrier 200).

Processor 140 may also have access through a communication module 144 to a communication channel 180 to communicate with a remote station. Communication channel 180 may, for example, be a Wide Area Network (“WAN”), telephone network, satellite network, or any other suitable communication channel. Communication module 144 may be any module suitable for the type of communication channel used, such as a computer network card, a computer fax card or machine, or a telephone or satellite modem. A reader may further communicate with processor 140.

The apparatus further includes a display 310, speaker 314, and operator input device 312. Operator input device 312 may, for example, be a keyboard, mouse, or the like. Processor 140 has access to a memory 141, and controls print head system 78 and print head 210 (e.g., the activation of the ejectors therein), operation of the transporter system and the third transporter 72, and operation of display 310 and speaker 314. Memory 141 may be any suitable device in which processor 140 can store and retrieve data, such as magnetic, optical, or solid state storage devices (including magnetic or optical disks or tape or RAM, or any other suitable device, either fixed or portable). Processor 140 may include a general purpose digital microprocessor suitably programmed from a computer readable medium carrying necessary program code, to execute all of the steps required by the present invention, or any hardware or software combination which will perform those or equivalent steps. The programming may be provided remotely to processor 141 through communication channel 180, or previously saved in a computer program product such as memory 141 or some other portable or fixed computer readable storage medium. For example, a magnetic or optical disk 324a may carry the programming, and can be read by disk writer/reader 326.

The operation of the fabrication station 20 will now be described. It will be assumed that a device 14 having prongs 104 on which arrays 12 are to be generated, is in position on station 20 and that processor 140 is programmed with the necessary layout information to fabricate one or more arrays on the top surfaces of one or more prongs of the device. Accordingly, it is assumed that device 14, with the modified surface such as a linking layer surface (if performed), has been transferred to station 20, at which station one or more arrays will be fabricated on one or more prongs of device 14 to provide an array assembly.

Using information such as target layout information and the number and location of drop deposition units in head 210, processor 140 may then determine a reagent drop deposition pattern. Alternatively, such a pattern may have been determined by another processor (such as a remote processor) and communicated to memory 141 through communication channel 180 or by forwarding a portable storage medium carrying such pattern data for reading by reader/writer 326.

For each array 12 to be fabricated, processor 140 may generate a corresponding unique identifier which may be stored in memory 141 in association with data on one or more characteristics of features 16 of the same array 12. Generation of such an identifier and feature characteristic data (in the form of array layout data) and their use are described, for example, in U.S. Pat. No. 6,180,351. Alternatively or additionally, such feature characteristic data and associated identifier for one or more arrays 12 which may be shipped to a user, may be stored onto a portable storage medium 324b by writer/reader 326 for provision to the remote customer.

Processor 140 controls fabrication, in accordance with the deposition pattern, to generate the one or more arrays on one or more prongs by depositing for each target feature during each cycle, a reagent drop set. Processor 140 controls fabrication of an array 12, by depositing one or more drops of each biopolymer or precursor unit onto a corresponding location of a feature 16 on a prong so as to fabricate the arrays 12 in the manner described herein. The deposited drops may contain one or more biopolymer or precursor unit depending on the feature composition desired. Where an activator is required (such as for phosphoramidites in the in situ method) this may provided in the same or different drops as the component requiring activation.

Processor 140 may also send device 14 to station 68 for intervening or final steps as required, all in accordance with the conventional in situ polynucleotide array fabrication process described above. In certain embodiments, device 14 may be cut into portions to provide a plurality of array assemblies such that the device may sent to a cutter (not shown) wherein portions of device 14 carrying one or more pronged-arrays may be separated from the remainder of the device, to provide multiple array assemblies. For example, the processed array may include 384 prongs, each having a chemical array thereon and the 384-pronged device may be cut into, e.g., four 96-pronged devices. In any event, one or more array assemblies 15 may then be placed in a package 340 (which may include portable storage medium 324b having array information contained thereon) and forwarded to one or more remote users to be used in an array assay. Optionally, characteristics of the fabricated arrays may be included in a code applied to the array assembly or a housing, or a file linkable to such code, in a manner as described in the foregoing patent application and U.S. Pat. No. 6,180,351, the disclosures of which are incorporated herein by reference. Data forwarded to a user, whether recorded on storage medium 324b and/or a code applied to the array assembly, may include information related to array layout information (including the location and identity of biopolymers at each feature), quality control data, biological function data, and the like.

As described above, a fluid contacting plate may be used in some or all of the above described operations. For example, a fluid contacting plate may be brought into position, e.g., using a robotic arm or the like, and operatively positioned relative to a base/prong device. The plate may be left in place for the remaining operations of the manufacturing process or may be removed in between certain operations. For example, a plate may be brought into position, e.g., using a robotic arm or the like, and operatively positioned relative to a base/prong device at a point prior to the time the device is transferred to station 20 (or the positioning may occur at station 20) and may be left in place throughout the rest of the array fabrication process. Alternatively, a plate may not be used at station 20, but may be used at station 68 (if present) such that a plate may be brought into position, e.g., using a robotic arm or the like, and operatively positioned relative to a base/prong device in between station 20 and optional station 68. Following the operations at station 68 (oxidation, deprotection, capping, washing, etc.), the plate may be removed from the device and the device may be transferred to station 20 for further processing, which positioning and removal of the fluid handling plate between stations may be repeated one or more times. For example, prior to using the chemical arrays in an array assay, embodiments may include a final deprotection step which may be an immersion of the entire array substrate containing the arrays with bases such as ethanolamine, methylamine, ammonia, etc., to remove the base protecting groups on the phosphoramidites.

During array fabrication errors may be monitored and used in any of the manners described in U.S. patent application “Polynucleotide Array Fabrication” by Caren et al., Ser. No. 09/302,898 filed Apr. 30, 1999, and U.S. Pat. No. 6,232,072.

A variety of different chemical arrays may be produced according to the subject methods including biopolymeric arrays such as nucleic acid arrays, peptide arrays, and the like.

Utility

The subject array assemblies find use in a variety of different applications, where such applications are generally analyte detection applications in which the presence of a particular analyte (i.e., target) in a given sample is detected at least qualitatively, if not quantitatively. Protocols for carrying out such assays are well known to those of skill in the art and need not be described in great detail here. Generally, the sample suspected of containing the analyte of interest is contacted with an array generated on a surface of a prong under conditions sufficient for the analyte to bind to its respective binding pair member (i.e., probe) that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface. Specific analyte detection applications of interest include, but are not limited to, hybridization assays in which nucleic acid arrays are employed.

In these assays, a sample to be contacted with an array may first be prepared, where preparation may include labeling of the targets with a detectable label, e.g. a member of signal producing system. Generally, such detectable labels include, but are not limited to, radioactive isotopes, fluorescers, chemiluminescers, enzymes, enzyme substrates, enzyme cofactors, enzyme inhibitors, dyes, metal ions, metal sols, ligands (e.g., biotin or haptens) and the like. Thus, at some time prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array may be labeled prior to or after contact, e.g., hybridization, with the array. In some embodiments of the subject methods, the sample analytes e.g., nucleic acids, are directly labeled with a detectable label, wherein the label may be covalently or non-covalently attached to the nucleic acids of the sample. For example, in the case of nucleic acids, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314).

In certain embodiments, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. Usually, a target with a fluorescent label includes a fluorescent group covalently attached to a nucleic acid molecule capable of binding specifically to the complementary probe nucleotide sequence.

Following sample preparation (labeling, pre-amplification, etc.), the sample may be introduced to the array using any convenient protocol, e.g., sample may be introduced using a pipette, syringe or any other suitable introduction protocol. The sample is contacted with the array under appropriate conditions to form binding complexes on the surface of the substrate by the interaction of the surface-bound probe molecule and the complementary target molecule in the sample. The presence of target/probe complexes, e.g., hybridized complexes, may then be detected. In those array assembly embodiments having at least one array on more than one prong, sample may be introduced to each array and maintained under suitable conditions for an array assay. In those embodiments having at least one array generated on two or more prongs, cross-contamination between sample contacted to the different arrays of different prongs is prevented due to the configuration of the prongs of the array assembly.

In the case of hybridization assays, the sample is typically contacted with an array under stringent hybridization conditions, whereby complexes are formed between target nucleic acids that agent are complementary to probe sequences attached to the array surface, i.e., duplex nucleic acids are formed on the surface of the substrate by the interaction of the probe nucleic acid and its complement target nucleic acid present in the sample. A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO4, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

The array is incubated with the sample under appropriate array assay conditions, e.g., hybridization conditions, as mentioned above, where conditions may vary depending on the particular biopolymeric array and binding pair.

Once the incubation step is complete, the array is typically washed at least one time to remove any unbound and non-specifically bound sample from the substrate, generally at least two wash cycles are used. Washing agents used in array assays are known in the art and, of course, may vary depending on the particular binding pair used in the particular assay. For example, in those embodiments employing nucleic acid hybridization, washing agents of interest include, but are not limited to, salt solutions such sodium chloride, sodium phosphate, EDTA (SSPE) and sodium chloride, sodium citrate (SSC) and the like as is known in the art, at different concentrations and which may include some surfactant as well. In certain embodiments the wash conditions described above may be employed.

Following the washing procedure, the array may then be interrogated or read to detect any resultant surface bound binding pair or target/probe complexes, e.g., duplex nucleic acids, to obtain signal data related to the presence of the surface bound binding complexes, i.e., the label is detected using colorimetric, fluorimetric, chemiluminescent, bioluminescent means or other appropriate means. The obtained signal data from the reading may be in any convenient form, i.e., may be in raw form or may be in a processed form. Accordingly, if arrays are present on each prong, each array may be interrogated or read to detect any resultant surface bound binding pair or target/probe complexes, e.g., duplex nucleic acids, to obtain signal data related to the presence of the surface bound binding complexes.

As such, in using an array assembly that includes one or more chemical arrays generated on a surface of a device that includes a base and a plurality of prongs, the array one or more arrays will typically be exposed to a sample (for example, a fluorescently labeled analyte, e.g., protein containing sample) and the one or more arrays then read. Reading of the array(s) to obtain signal data may be accomplished by illuminating the array(s) and reading the location and intensity of resulting fluorescence (if such methodology was employed) at each feature of the array(s) to obtain a result. For example, array scanners that may be used for this purpose include an Agilent MICROARRAY SCANNER available from Agilent Technologies, Palo Alto, Calif., and a Tecan LS Scanner. Other suitable apparatus and methods for reading an array to obtain signal data are described in U.S. patent application Ser. Nos: Ser. No. 09/846,125 “Reading Multi-Featured Arrays” by Dorsel et al.; and Ser. No. 09/430,214 “Interrogating Multi-Featured Arrays” by Dorsel et al., the disclosures of which are herein incorporated by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583, the disclosure of which is herein incorporated by reference, and elsewhere).

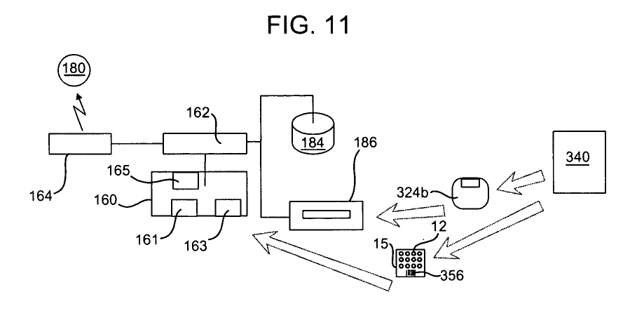

One such system for reading an array produced according to the subject methods is shown in FIG. 11. which illustrates an array reader at a single “user station”, which may (but not necessarily) be remote from the fabrication station of FIG. 10 (usually the user station is at the location of the customer which ordered the fabricated, received array). The user station may include a processor 162, a memory 184, a scanner 160 which may read arrays present on prongs, data writer/reader 186 which may be capable of writing/reading to the same type of media as writer/reader 326), and a communication module 164 which also has access to communication channel 180. Processor 162 is programmed to perform all the functions required of it. Scanner 160 may include a holder 161 which receives and holds an array assembly, as well as a source of illumination (such as a laser) and one or more light sensors 165 to read fluorescent light signals from respective features on the array assembly as signal data which is obtained by processor 162 from the light sensor. Scanner 160 may also include a reader 163 to read identifier 356 appearing on an array assembly in certain embodiments.

Communication module 164 may be any type of suitable communication module, such as those described in connection with communication module 144. Memory 184 may be any type of memory such as those used for memory 141. Scanner 160 may be any suitable apparatus for reading an array, such as one which can read the location and intensity of fluorescence at each feature of an array following exposure to a fluorescently labeled sample. For example, such a scanner may be similar to the MICROARRAY SCANNER available from Agilent Technologies, Inc. Palo Alto, Calif. Other suitable apparatus and methods are described in U.S. patent applications: Ser. No. 09/846,125 “Reading Multi-Featured Arrays” by Dorsel et al.; and U.S. Pat. No. 6,406,849. The scanning components of scanner 160, holder 161, and reader 163 may all be contained within the same housing of a single same apparatus.

At the user station, package 340 may be received. For example, embodiments may include using a multi-prong array assembly at the user station of FIG. 11, by receiving a package 340 from the remote fabrication station of FIG. 10 and opening the package to retrieve the prepared array assembly and portable storage medium 324b (if present in package 340). In certain embodiments, an array assembly may be positioned in a rigid carrier and received by a user in such configuration such that the arrays may be read by a scanner while associated with a carrier. Sample, for example a test sample, may be exposed to the one or more received arrays in a known manner under known conditions. Apparatus and procedures for hybridization are described, are described herein elsewhere. Following hybridization and washing, the array may then be inserted into holder 161 in scanner 160 and read by it to obtain read results (such as signal data representing the fluorescence pattern on the array 12). In certain embodiments, the reader 163 in scanner 160 may also read the identifier 356 in association with the corresponding array(s), while the array assembly is still positioned in retained in holder 161 or beforehand. In certain embodiments, using identifier 356, processor 162 may then retrieve the characteristic data such as, e.g., the relative addresses and compositions thereof, for one or more of the arrays from e.g., portable storage medium 324b or from the database of such information in memory 141, or the like.

The resulting retrieved characteristic data for arrays of the array assembly may be used to either control reading of the arrays or to process information obtained from reading the arrays. For example, the customer may decide (through providing suitable instructions to processor 162) that a particular feature need not be read or the data from reading that feature may be discarded, since the polynucleotide sequence at that feature is not likely to produce any reliable data under the conditions of a particular sample hybridization.

It is possible that the array assembly may be contained within a housing (not shown). Such a housing may include a chamber carrying the array assembly which may be viewable through a window of the housing during interrogation. The chamber may be accessible through one or more ports that may be normally closed by ports or doors. In such a case, the identifier may alternatively be written on the housing itself, rather than on the array assembly.

Regardless of the methods and devices that may be used to read arrays of an array assembly, in certain embodiments the results of the array reading (processed or not) may be forwarded (such as by communication) to a remote location if desired, and received there for further use (such as further processing). By “remote location” is meant a location other than the location at which the sample evaluation device is present and sample evaluation occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, Internet, etc.

As noted above, the arrays produced according to the subject method may be employed in a variety of array assays including hybridization assays. Specific hybridization assays of interest which may be practiced using the subject arrays include: gene discovery assays, differential gene expression analysis assays; SNP analysis, nucleic acid sequencing assays, and the like. Patents describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference.

Other array assays of interest include those where the arrays are arrays of polypeptide binding agents, e.g., protein arrays, where specific applications of interest include analyte detection/proteomics applications, including those described in U.S. Pat. Nos. 4,591,570; 5,171,695; 5,436,170; 5,486,452; 5,532,128; and 6,197,599; as well as published PCT application Nos. WO 99/39210; WO 00/04832; WO 00/04389; WO 00/04390; WO 00/54046; WO 00/63701; WO 01/14425; and WO 01/40803.

Kits

Finally, kits are also provided. The subject kits may include one or more array assemblies that include one or more chemical arrays generated on one or more prongs of a device that includes a base supporting a plurality of prongs. Embodiments may include one or more fluid contacting plates for use with the array assemblies, e.g., for use in an array assay.

The kits may further include one or more additional components necessary for carrying out an analyte detection assay, such as sample preparation reagents, buffers, labels, and the like. As such, the kits may include one or more containers such as vials or bottles, with each container containing a separate component for the assay, and reagents for carrying out an array assay such as a nucleic acid hybridization assay or the like. The kits may also include a denaturation reagent for denaturing the analyte, buffers such as hybridization buffers, wash mediums, enzyme substrates, reagents for generating a labeled target sample such as a labeled target nucleic acid sample, negative and positive control targets.

The subject kits may also include written instructions for using the array assemblies in an array assay such as a hybridization assay, protein binding assay, or the like. A kit may also include written instructions for using a fluid contacting plate with an array assembly to contact fluid with a defined region of the array assembly, e.g., for use in an array assay. Instructions of a kit may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

In many embodiments of the subject kits, the components of the kit are packaged in a kit containment element to make a single, easily handled unit, where the kit containment element, e.g., box or analogous structure, may or may not be an airtight container, e.g., to further preserve the one or more chemical arrays and reagents, if present, until use.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method of fabricating an array assembly comprising generating at least one chemical array comprising an addressable set of probes on a surface of at least one prong of a device comprising a base supporting a plurality of prongs.

2. The method of claim 1, wherein said generating comprises depositing fluid from a deposition device onto said surface of said at least one prong.

3. The method of claim 2, further comprising operatively positioning said at least one prong relative to said fluid drop deposition device prior to depositing fluid from said deposition device onto said surface of said at least one prong.

4. The method of claim 1, further comprising fabricating said device prior to said generating step.

5. The method of claim 4, wherein said fabricating comprises providing a precursor device and overlying said precursor device with one or more layers.

6. The method of claim 5, wherein said one or more layers are chosen from a light returning layer, optically transparent layer, and a bonding layer.

7. The method of claim 6, wherein said fabricating comprises overlaying said precursor with at least two layers.

8. The method of claim 7, wherein at least one of said layers is a light returning layer.

9. The method of claim 8, wherein said light returning layer is a metal or metal oxide layer.

10. The method of claim 6, wherein at least one of said layers is an optically transparent layer.

11. The method of claim 10, wherein said optically transparent layer is glass.

12. The method of claim 7, wherein said fabricating comprises overlaying said precursor with a light returning layer and then overlaying said light returning layer with an optically transparent layer.

13. The method of claim 1, further comprising associating said device with a fluid contacting plate comprising a planar support having a plurality of holes so that said holes of said support are aligned with said prongs of said device.

14. The method of claim 1, wherein said method comprises generating a plurality of arrays of addressable sets of probes, wherein at least two arrays are generated on two different prongs.

15. The method of claim 14, wherein said at least two arrays are different from each other.

16. The method of claim 1, wherein said probes are nucleic acids.

17. The method of claim 1, wherein said probes are peptides or proteins.

18. The method of claim 1, wherein said method comprises providing a structure having a plurality of prongs interconnected by coplanar web, generating at least one chemical array of an addressable set of probes on a surface of at least one prong of said structure, and removing said interconnected web to produce a device comprising a base supporting a plurality of prongs that includes least one chemical array of an addressable set of probes on a surface of at least one prong.

19. An array assembly comprising a base supporting a plurality of prongs, wherein at least one prong comprises at least one array of an addressable set of probes generated on a surface of said prong.

20. The array assembly of claim 19, wherein said array assembly comprises at least two of said arrays.

21. The array assembly of claim 20, wherein said at least two arrays are different.

22. The array assembly of claim 19, wherein said array assembly includes a fluid contacting plate.

23. The array assembly of claim 19, wherein said plurality of prongs are interconnected by a surface coplanar with a surface of said prongs.

24. A method of performing an array assay, said method comprising:
(a) contacting sample to an array assembly comprising at least one array of an addressable set of probes generated on a surface of a prong of a device comprising a base supporting a plurality of prongs; and
(b) detecting the presence of any binding complexes on said surface of said prong.

25. The method of claim 25, wherein said method further comprises positioning a fluid contacting plate comprising a plurality of holes relative to a surface of said array assembly and introducing said sample through at least one hole of said fluid contacting plate to contact said sample to at least one array of an addressable set of probes.

26. The method of claim 24, comprising contacting the same or different sample to a plurality of arrays of addressable sets of probes, wherein at least two of said arrays are present on different prongs.

27. The method of claim 26, wherein said method comprises contacting the same or different sample to a plurality of arrays of addressable sets of probes at the same time, wherein at least two of said arrays are present on different prongs.

28. The method of claim 26, wherein said method comprises contacting the same or different sample to a plurality of arrays of addressable sets of probes at different times, wherein at least two of said arrays are present on different prongs.

29. A system for fabricating an array assembly, said system comprising:
(a) a device comprising a base supporting a plurality of prongs; and
(b) an apparatus for generating an array of an addressable set of probes on a surface of at least one of said prongs.

30. A kit comprising:
(a) an array assembly comprising a base supporting a plurality of prongs, wherein at least one prong comprises at least one array of an addressable set of probes generated on a surface of said prong; and
(b) reagents for performing an array assay.
